(19) United States
(12) Patent Application Publication
(10) Pub. No.: US 2026/0152117 A1
(43) Pub. Date: Jun. 4, 2026

(54) REAR COLLISION WARNING DEVICE FOR A TRUCK TRAILER

(71) Applicant: GROTE INDUSTRIES, INC., Madison, IN (US)

(72) Inventors: ADAM SLADE, MADISON, IN (US); DEVIN HARRIS, VEVAY, IN (US)

(73) Assignee: GROTE INDUSTRIES, INC., Madison, IN (US)

(21) Appl. No.: 19/457,406

(22) Filed: Jan. 23, 2026

Related U.S. Application Data
(63) Continuation-in-part of application No. 18/814,639, filed on Aug. 26, 2024.

(51) Int. Cl. B60Q 1/50; B60D 1/62; B60Q 9/00; G01S 13/931; H04L 12/40

(52) U.S. Cl. CPC B60Q 1/535; B60D 1/62; B60Q 9/008; G01S 13/931; H04L 12/40; H04L 2012/40215; H04L 2012/40273

(57) ABSTRACT

A rear collision warning device for trailers that may include one or more sensors, a control circuit, and one or more warning devices. In one aspect, the sensors are configured to monitor a predetermined zone behind and/or alongside a trailer and to optionally trigger warnings as predetermined criteria are satisfied. In another aspect, the control circuit controls the warning devices to emit a warning signal in the form of flashing lights, strobes, audible alarms, and the like, or to send warning notifications to a remote server, an app, or to a cab mounted display. The sensors, circuits, and warning devices are optionally mounted together in a separate housing and mounted at or near the side and/or rear of the trailer.

This application is a Continuation-in-Part of U.S. patent application Ser. No. 18/814,639 filed on Aug. 26, 2024 which is incorporated herein by reference.

### BACKGROUND

The present disclosure relates generally to a rear collision warning device or system for a trailer towed by a truck or other vehicle, and/or for a truck itself. Rear end collisions account for a large percentage of all motor vehicle collisions and are responsible for a correspondingly high percentage of injuries. Many vehicles in recent years have come equipped with forward collision warning systems that alert drivers of imminent collisions and optionally automatically apply the brakes if necessary. However, vehicles often do not include rear collision warning systems that include a rear-facing warning indicators. Thus, vehicles approaching quickly from the rear may not be given any warning that a collision is imminent.

### SUMMARY

Disclosed is a rear collision warning device or system configurable for use on a truck, trailer, bus, or other large vehicle. The rear collision warning device generally includes one or more rear-facing sensors, a control circuit electrically connected to the rear-facing sensors, and one or more warning devices electrically connected to the control circuit. In one aspect, the sensors monitor a predetermined zone behind the tractor-trailer. When an object is detected within the predetermined zone, and/or the object has a closure rate that exceeds a warning threshold, the control circuit may generate commands, signals, or other output indicating a collision is imminent. Some of these signals may be provided to the driver of the leading vehicle (i.e. the vehicle about to be hit) such as in the case of a cab mounted lamp, buzzer, or a notification sent to an app that is displayed for the driver to see. In another aspect, the signals may be useful for triggering a rear-facing warning device such as a lamp, strobe, buzzer, or other such device useful for notifying the oncoming vehicle that a collision is imminent. In one example, the signals may include a command electrically sent from the control circuit to one or more warning lamps which may be positioned on the trailer, or on the truck that is towing the trailer. The warning lamps may emit light until receiving a command from the control circuit indicating that the collision is no longer imminent.

Some of the disclosed trailer wiring systems are described in U.S. Pat. No. 10,926,594 “Cable system for a truck trailer”, and U.S. Pat. No. 11,518,205 “Smart cable system for a truck trailer” both of which are hereby incorporated by reference in their entirety.

Further forms, objects, features, aspects, benefits, advantages, and examples of the present invention will become apparent from the claims, detailed description, and drawings provided herewith.

### BRIEF DESCRIPTION OF THE DRAWINGS

FIG. 1 is a component diagram illustrating an example of components that may be included in a rear collision warning device of the present disclosure.

FIG. 2 is a chart illustrating examples of different alert thresholds that may be implemented by a rear collision warning device of the present disclosure.

FIG. 3 is a component diagram illustrating additional aspects of a rear collision warning device of the present disclosure.

FIG. 4 is a diagram illustrating additional locations for rear-facing warning devices that may be activated by a rear collision warning device of the present disclosure.

FIG. 5 is a component diagram illustrating additional aspects of an operator indicator for use in conjunction with a rear collision warning device of the present disclosure.

FIG. 6 is a component diagram illustrating another example of components that may be included in a rear collision warning device of the present disclosure.

FIG. 7 is a component diagram illustrating aspects of a trailer wiring system that may be used in conjunction with a rear collision warning device of the present disclosure.

FIG. 8 is a component diagram illustrating aspects of a trailer wiring system that may be used in conjunction with a rear collision warning device of the present disclosure.

FIG. 9 is a component diagram illustrating aspects of a trailer wiring system that may be used in conjunction with a rear collision warning device of the present disclosure.

FIG. 10 is a component diagram illustrating aspects of a trailer wiring system that may be used in conjunction with a rear collision warning device of the present disclosure.

FIG. 11 is a component diagram illustrating aspects of a trailer wiring system that may be used in conjunction with a rear collision warning device of the present disclosure.

FIG. 12 is a component diagram illustrating aspects of a trailer wiring system that may be used in conjunction with a rear collision warning device of the present disclosure.

FIG. 13 is a component diagram illustrating aspects of a camera system that may be used in conjunction with a rear collision warning device of the present disclosure.

### DETAILED DESCRIPTION

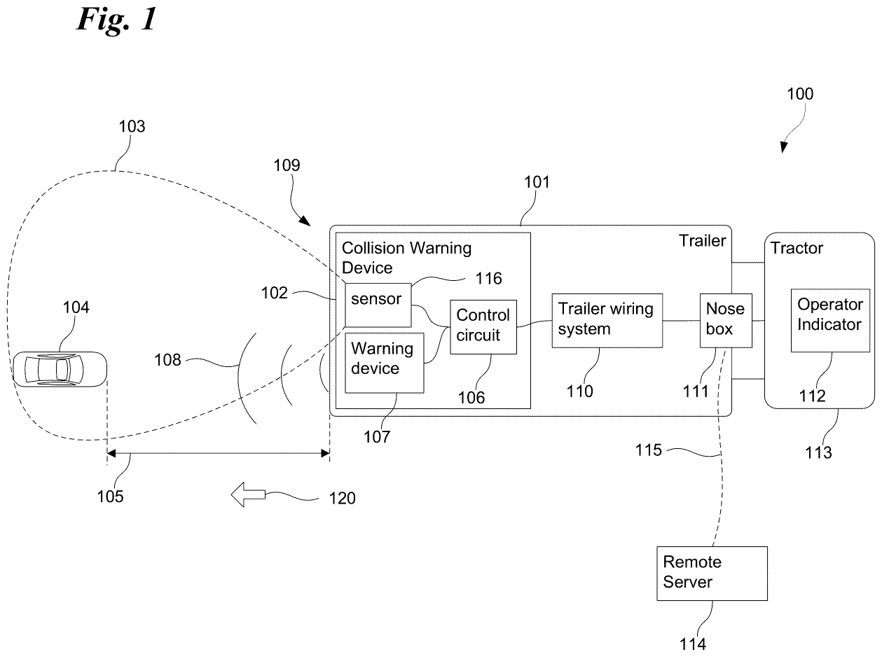

FIG. 1 illustrates at 100 aspects of a rear collision warning device or system for a trailer 101 optionally towed by a truck/tractor 113. The rear collision warning device 102 of the present disclosure is optionally useful with other large vehicles, dump trucks, firetrucks, delivery vans, and the like. The warning device optionally includes a rear-facing sensor 116 defining a detection zone 103 that optionally extends outwardly behind and away from the trailer in a rear direction 120. The rear-facing sensor is optionally operable to detect a following vehicle 104 behind the trailer, and to determine the distance 105 between the trailer and the following vehicle. In another aspect, the rear-facing sensor optionally emits electromagnetic energy to detect the following vehicle that has a frequency ranging between 100 MHz and 100 PHz. This electromagnetic energy may include, but not be limited to, radar, lidar, or other energy suitable for the detection of the following vehicle.

The collision warning device optionally includes a control circuit 106 that is optionally responsive to the rear-facing sensor. The collision warning device, control circuit, rear-facing sensor, and other aspects of the disclosed collision warning device or system are optionally electrically connected to a trailer wiring system 110 which may include multiple power cables, a ground cable, or other cables optionally for carrying data between the collision warning device and other systems in the trailer and/or the tractor.

The trailer wiring system 110 may include, or be electrically connected to, a nose box 111 mounted to the trailer. The nose box may be arranged and configured to electrically connect with electrical circuits of the tractor thus optionally providing power, ground, and/or data connections between the trailer and the tractor. In another aspect, the collision warning device optionally receives power from a metallic power cable of the trailer wiring system that provides up to 12 volts to the sensor, or optionally up to 18 volts, up to 24 volts, up to 40 volts, or 40 volts or more to the sensor. In another aspect, the sensor optionally communicates with the trailer nose box via a data bus in the trailer, and the collision warning device may optionally receive power from a metallic power cable of the trailer that provides more than 18 volts to the rear-facing sensor, or optionally more than 20 volts to the rear-facing sensor. Any suitable voltage may be carried by the trailer wiring system.

In another aspect, the sensor communicates with the trailer nose box via the metallic power cables, and/or via a data bus of the trailer wiring system. This data bus optionally includes one or more data cables arranged and configured to carry data from the collision warning device through the trailer wiring system to the nose box, and optionally to the tractor as well, and/or a remote server 114. Data about the performance, operation, collision warnings, or other useful information is optionally sent to the remote server via a communication link 115 between the remote server in the nose box. In another aspect, data received from the collision warning device may be collected, aggregated, or otherwise processed by the nose box before it is delivered to the remote server. The nose box optionally uploads data to the remote server at predetermined time intervals, or when the remote server request for data to be sent from the nose box. The control circuit is thus optionally configured to send collision warning notifications to the remote server via the data bus electrically connected to the trailer nose box.

The control circuit 106 may be configured to determine one or more suitable collision parameters which include, but are not restricted to combinations of any of the following: (a) the time to collision (TTC); (b) the distance 105 between the sensor and the following vehicle; and/or (c) the closure rate between the sensor and the following vehicle. In another aspect, the control circuit may be operable to detect the distance from the trailer to the following vehicle and/or the speed of the following vehicle relative to the earth or relative to the trailer. In another aspect, the control circuit is optionally operable to determine a speed differential based on input received from the rear-facing sensor, and the speed differential in this example may be defined as a difference in speed between the truck trailer and the following vehicle.

In another aspect, the following vehicle may be moving faster than the trailer, thus closing the distance between the trailer and the following vehicle and reducing the TTC as the following vehicle comes closer. The time-to-collision is directly related to the speed differential between the trailer and the following vehicle. A positive speed differential optionally means the distance between the trailer and the following vehicle is narrowing as the following vehicle closes on the trailer, and a negative speed differential optionally indicates the distance between the following vehicle and the trailer is widening. In another aspect, a TTC may not be calculated by the control circuit in the case where the speed differential is negative because in that instance the following vehicle is not gaining on the trailer and cannot overtake it.

The collision warning device also optionally includes a rear-facing warning device 107 that is optionally responsive to the control circuit and may be operable to emit a warning signal 108 toward the following vehicle. The warning signal may include lamps, or other indicators emitting visible light that may also be configured to flash, pulsate, alternate colors, and the like in order to warn the following vehicle that a collision may soon occur. In another aspect, the rear-facing sensor and the rear-facing warning device are optionally mounted adjacent the rear of the trailer at 109. In another aspect, the warning device optionally includes an operator indicator 112 mounted in a cab of the truck coupled to the trailer. The operator indicator may be responsive to the control circuit to display a warning for the driver of the truck when a collision warning is triggered.

In another aspect, the control circuit is optionally configured to trigger collision warnings according to one or more criteria. These criteria may be programmed into the control circuit and maintained in a memory of the circuit and may optionally be accessed or executed by control logic such as a microcontroller, microprocessor, and the like. The criteria may be implemented in any suitable fashion such as one or more rules, lookup tables, decision trees, and the like.

In another aspect, the memory of the control circuit may be useful for capturing and storing data obtained from the rear-facing sensor. This data optionally includes raw sensor data values obtained directly from the rear-facing sensor, intermediate results of calculations useful in determining whether a collision warning should be sent, as well as any other useful data available to the collision warning device. On one aspect, the memory optionally retains TTC data captured at specific times and saved with timestamps in a file or other data repository. In another aspect, the memory optionally retains distances, closure rates, corresponding speed changes made by the trailer and the following vehicle, and the like. Any data generated by the rear facing sensor, or computational outcomes generated by the control circuit may be captured for later analysis.

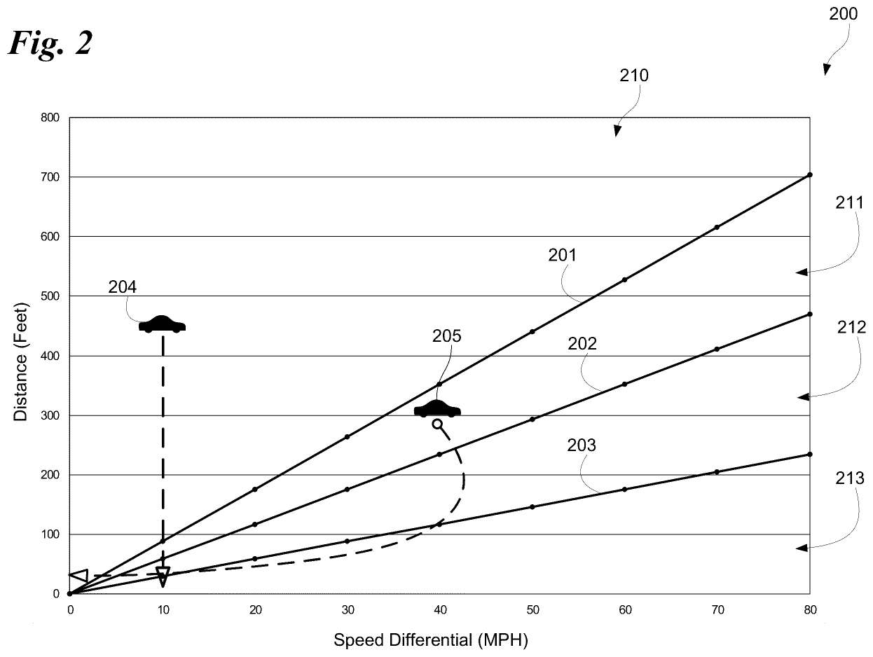

One example of such criteria is illustrated at 200 in FIG. 2 as a series of curves that may be programmed into the control circuit in suitable fashion. The triggering criteria optionally includes predetermined thresholds specifying a first warning when the TTC is less than six seconds, a second different warning when the TTC is less than four seconds, and third different warning when the TTC is less than two seconds. As shown in FIG. 2, the triggering criteria optionally includes the distance from the trailer to the following vehicle and the speed differential between the trailer and the following vehicle. These may be determined by the control circuit based on input from the rear-facing sensor and useful for determining when to trigger a particular warning response.

A six-second TTC relative to speed and distance is illustrated at 201, while a four-second TTC is illustrated at 202, and a two-second TTC at 203. Other curves may also be relevant and these may be optionally programmed into the control circuit as well, or instead of the illustrated curves in FIG. 2. In this configuration, the relationship between the speed differential and the distance from the trailer to the following vehicle is optionally programmed into the control circuit thus defining four zones of interest with the first zone 210 arranged and configured to address warning signals for following vehicles that are more than six seconds away from impacting the trailer. A second zone 211 is defined as a warning signal response for following vehicles that are between six and four seconds away from impacting the trailer. A third zone 212 may be defined to handle warning signal responses for vehicles that are between two and four seconds away from colliding with the trailer, while a fourth zone 213 id optionally included to account for imminent collision situations where the following vehicle is two seconds away or less from colliding with the trailer.

In one example at 204, the control circuit working in concert with the rear-facing sensor detects a following vehicle approaching the rear of the trailer with a positive speed differential of 10 miles per hour-meaning the following vehicle is moving 10 miles per hour faster than the trailer. In this example, a rear-facing sensor of the present disclosure first detects the vehicle 204 at a range of about 450 feet away from the rear of the trailer. At this range, and given the present speed differential of 10 mph, the control circuit is optionally programmed to issue no warning. The control circuit is optionally configured and programmed according to the illustrated curves so that when the vehicle 204 closes to less than about 88 feet, a first warning signal may be generated by the warning device to alert the oncoming driver and/or the driver of the truck coupled to the trailer, that a collision will occur in under six seconds if the current speed differential is maintained.

When the current speed differential remains at 10 mph, the control circuit is optionally programmed to activate a second stage warning signal using the warning device when the vehicle closes to less than about 58 feet thus informing the driver of the following vehicle (and possibly the truck) that a collision will occur in less than four seconds absent a change in the speed differential. The control circuit may be optionally configured to generate a third, or final stage, warning when the vehicle approaches to less than about 29 feet from the trailer thus providing a warning to the oncoming vehicle (and optionally to the driver of the truck as well) that a collision with the trailer is eminent.

In another example at 205, the control circuit receives input from the rear-facing sensor indicating that a following vehicle is approaching the rear of the trailer with a positive speed differential of about 40 mph. In this example, the sensor first detects the vehicle 205 at a distance of about 290 feet which is within the second zone 211. This might occur, for example, where the trailer is stopped at an intersection and a hill obscures the presence of the following vehicle 205 until it comes over the hill and is detectable by the rear-facing sensor. The control circuit is optionally configured to automatically activate the warning device to display a first level warning to the following vehicle (and optionally a warning to the driver of the truck towing the trailer).

In this example, the following vehicle 205 accelerates somewhat to increase the speed differential to about 45 mph and this matches the criteria programmed into the control circuit for activating a second warning indication as the distance to the following vehicle closes to about 250 feet or less. The speed differential begins to drop shortly thereafter, although not quickly enough to avoid satisfying the third stage criteria as the following vehicle comes within about 115 feet of the trailer with a speed differential of about 40 mph. The following vehicle continues to close on the trailer while the third stage warning indicator is activated by the collision warning device and is (hopefully) visible to the driver. The distance between the trailer and the following vehicle then begins to drop quickly, as does the speed differential, as the driver of the following vehicle begins braking aggressively, or as the trailer begins to move faster, or any combination thereof. Here the crisis is averted as the distance between the vehicles drops to about 25 feet as the two vehicles equalize speeds and the differential reaches 0 mph and then goes negative (meaning the distance between the trailer and the following vehicle is now increasing). As this occurs, the control circuit of the present disclosure automatically deactivates the third stage warning indicator, the second stage warning indicator, and finally the first stage warning indicator as the danger of collision passes.

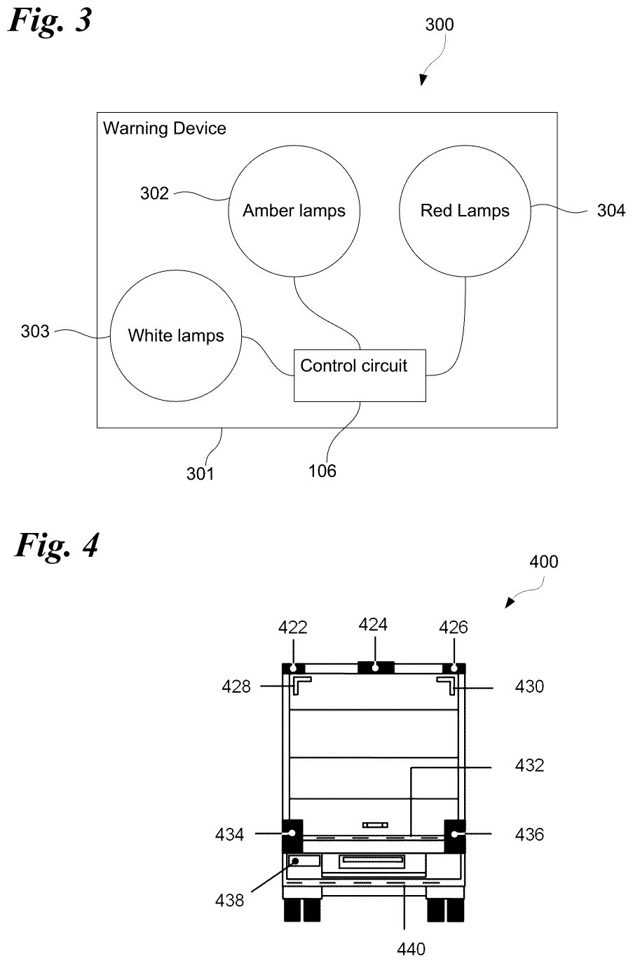

In another aspect, a warning device of the present disclosure may include one or more lamps which may be operable to send a warning signal via visible light to the driver of a following vehicle. Examples of lamps that may be included in the warning device are shown at 300 in FIG. 3. The warning device of the present disclosure optionally includes one or more amber lamps 302, one or more white lamps 303, and/or one or more red lamps 304. These lamps optionally include LED lamps, incandescent bulbs, strobe bulbs, or any other lamp suitable for emitting light, preferably in the visible light spectrum for the purpose of warning a driver of a following vehicle. The lamps are electrically connected to a control circuit of the present disclosure and responsive to commands, signals, or activation by the control circuit to emit light when the control circuit determines that a warning is required.

As discussed above, the control circuit optionally activates different lamps at different stages of detection based on varying criteria to increase or decrease the warning indicators directed toward the following vehicle according to the likelihood of a collision between the following vehicle and trailer. For example, the control circuit optionally activates the amber lamps of the warning device when the first warning is triggered, such as when a vehicle is in the second zone 211. In another aspect, the control circuit optionally activates the red lamps of the warning device when the second warning is triggered, such as when a vehicle is in the third zone 212, and the red and amber lamps of the warning device when the third warning is triggered, such as in the fourth zone 213. In another example, the white lamps may be activated at one or all of these stages either instead of or in concert with the other lamps.

FIG. 4 illustrates another example of lamps used in conjunction with or as part of a warning device of the present disclosure. Existing trailer components such as lamps mounted to the trailer according to the Federal Motor Vehicle Safety Standards (FMVSS) for lamps and reflective devices found in 49 CFR 393.11 may be activated or deactivated using the disclosed warning system to deliver the warning signal to the following vehicle.

FIG. 4 illustrates a dry van or box type semi-trailer 400 as an illustration that is not restrictive. Any existing trailer such as a bulk liquid carrier, flatbed trailer, log trailer, and the like, that includes existing trailer components configured to emit light may be configured as disclosed herein so that the existing lamps may be activated and deactivated as needed. In the example at 400, the warning device may be operable to activate one or more left rear clearance lamps 422, rear identification lamps 424, right rear clearance lamps 426, and/or lamps which may appear at the rear upper body marking 428, and rear upper body marking 430 which are arranged along the top portion of the rear of the trailer. Similarly, a collision warning device of the present disclosure may be configured to activate lamps at or near the bottom of the trailer such as the left rear stop turn tail lamps 434, and right rear stop turn tail lamps 436. These may be arranged on opposite sides with rear lower body marking 432 extending between, license plate lamp(s) 438 which may also be activated or deactivated to provide a warning signal, but which otherwise provide lighting around the license plate area. In another aspect, lamps mounted at the bumper bar marking 440 generally used for providing markings near the bottom rear of the truck trailer may also be employed to emit a warning signal. In another aspect, other lamps of a trailer such as those at the top front and sides like the front clearance lamps, upper front left side marker lamps, and upper intermediate left side marker lamps automatically activated and deactivated as well.

In another aspect, lamps of the warning device of the present disclosure are optionally activated at a first intensity for the first warning sent to a following vehicle, at a second higher intensity for the second warning, and at third intensity for the third warning. Each successive warning may optionally emit a more intense warning that is successively brighter, longer, includes flashing or other intermittent light emissions, in hopes of gaining the attention of the driver of the following vehicle before the collision occurs. Each successive warning may employ additional lamps, or the same lamps emitting light at a higher intensity, or as discussed herein elsewhere, lamps emitting different colors of light or using different types of lamps depending on the warning level.

For example, in the case of an initial or first level warning, amber lamps may be intermittently activated and deactivated at a first lower intensity, whereas at the highest level of warning, the same lamps may be activated and deactivated at a faster rate, or at a higher intensity. In another example, for the first level of warning, amber lamps may be flashed in the direction of the following vehicle at a first intensity, red lamps may be flashed along with the amber lamps at about the same intensity for the second level warning, and then white strobe lights may be activated intermittently along with the red and amber lamps for the third and highest level warning.

In yet another example, existing clearance lamps and tail lamps of the trailer may be automatically activated to flash at a first intensity at a predetermined lower rate for the first level warning. In the event that the driver the following vehicle does not respond, then optionally all of the break lamps, tail lamps, turn signal lamps, clearance lamps, and the like visible from behind the trailer may be flashed at the highest intensity possible and at a higher predetermined rate to initiate the second level warning. The highest level warning may optionally include strobes, audible sirens or horns, or other additional warning signals that may be directed toward the driver the following vehicle. These audible warning devices may already be included in the trailer and activated by the warning device of the present disclosure, or may be added to the trailer as part of the warning device or warning system. As discussed in further detail herein elsewhere, the collision warning device of the present disclosure is optionally configured to initiate the activation of other trailer components to aid in alerting the driver of the following vehicle. This may be accomplished by sending signals or commands from the nose box after the collision warning system has informed control logic in the nose box that a collision may occur.

In another aspect, the operator indicator of the present disclosure may be mounted in a cab of the truck coupled to the trailer, and be operable to display a warning for the driver of the truck when a collision warning is triggered. This operator indicator may include any arrangement of lamps, audible alarms, computers, display devices, and the like, which are in communication with the collision warning device.

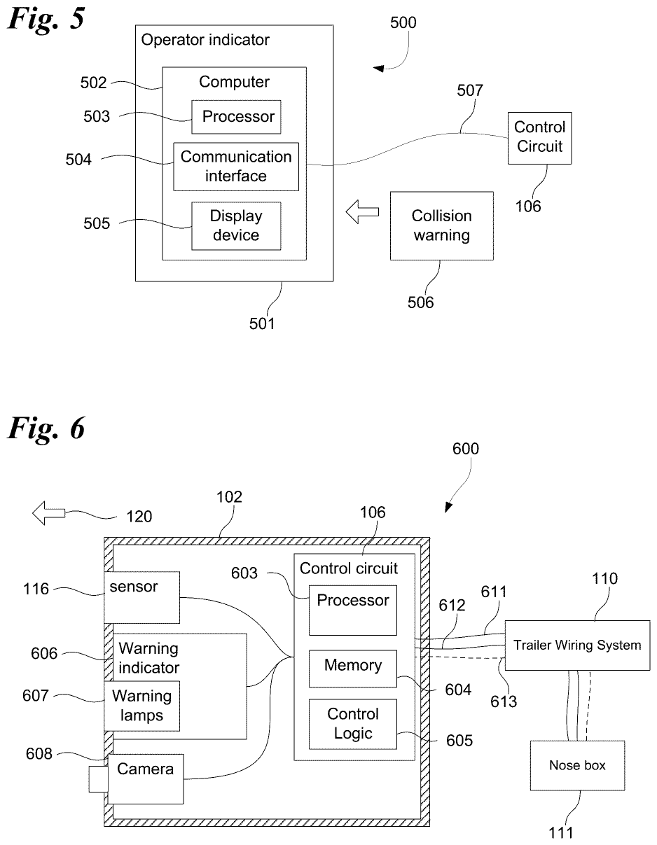

One example is illustrated at 500 in FIG. 5. An operator indicator 501 of the present disclosure is shown having a computer 502 that includes a processor 503, display device 505, and a communication interface 504. The communication interface optionally establishes and/or maintains a communication link 507 between the operator indicator and the collision warning device so that collision warnings 506 may be sent by the control circuit 106 to the operator indicator. The operator indicator is thus responsive to the control circuit and is arranged and configured to display a warning for the driver of the truck when a collision warning is triggered by the control circuit. As discussed herein elsewhere, the communication link between the control circuit and the operator indicator may include aspects of the trailer wiring system such as a data bus in the trailer, a control circuit in the nose box of the trailer, and any suitable combination of wired or wireless communication protocols for establishing the communication link between the control circuit 106 and the operator indicator.

Another example of optional components that may be included in a collision warning device for a truck trailer is illustrated at 600 in FIG. 6. The disclosed collision warning device illustrated is optionally multiple at or adjacent to the rear of a trailer of the present disclosure. As with other warning devices of the present disclosure, the warning device 600 includes a sensor of the present disclosure facing in the rear direction that is arranged and configured to detect a following vehicle behind the trailer. Following vehicles entering the detection zone may be detected by the sensors of the present disclosure to determine aspects of the vehicle relevant to determining whether the vehicle will hit the trailer given its relative speed with respect to the trailer as it changes over time.

The control circuit is optionally responsive to the sensor, and the control circuit is optionally configured to determine a TTC for the following vehicle, to compare the time to collision to triggering criteria, and to trigger a collision warning when the triggering criteria are satisfied. The triggering criteria are optionally stored in a memory 604, and executed by a processor 603 according to control logic 605.

The warning indicator optionally includes one or more of warning lamp 607 which may be configured as disclosed herein elsewhere to emit amber, red, white, or other suitable colors of light. As is also discussed herein elsewhere, the warning lamps may be activated according to triggering criteria that optionally includes predetermined thresholds specifying activation of the warning lamps. The warning lamps optionally include one or more amber lamps which are optionally activated when the TTC is less than six seconds, or one or more red lamps that may be activated when the TTC is less than four seconds. In another aspect, the red and amber lamps are optionally triggered together when the TTC is less than two seconds. As disclosed herein, the lamps of the warning device include LEDs, incandescent bulbs, strobes, or any other suitable light-emitting device.

In another aspect, the control circuit is electrically connected to the trailer wiring system 110 by at least a power cable 611, a ground cable 612, and optionally by a data cable (or cables) 613. These power, ground, and data cables optionally electrically connect the collision warning device with the nose box of the trailer

In another aspect, the collision warning device optionally includes a housing 601 that contains the sensor, the warning indicator and any associated warning lamps, and the control circuit. The housing is optionally mountable at the rear of the trailer as a self-contained unit that optionally requires only a power and ground electrical connection in order to be operable. In this example, a collision warning device of the present disclosure may be added to an existing trailer with a minimum of integration steps. The housing may, for example, need only to be physically coupled to the trailer, preferably at the rear of the trailer, with electrical power provided by the power and ground circuits. The sensor, optional camera, warning lamps, and other aspects of the disclosed warning device are optionally configured to automatically activate the warning device to begin emitting following vehicles based on the criteria in the control circuit. This reduces or eliminates reliance on existing trailer wiring, trailer lighting, trailer cameras, or other complex wiring or telematics systems in order to provide the rear warning signals of the present disclosure.

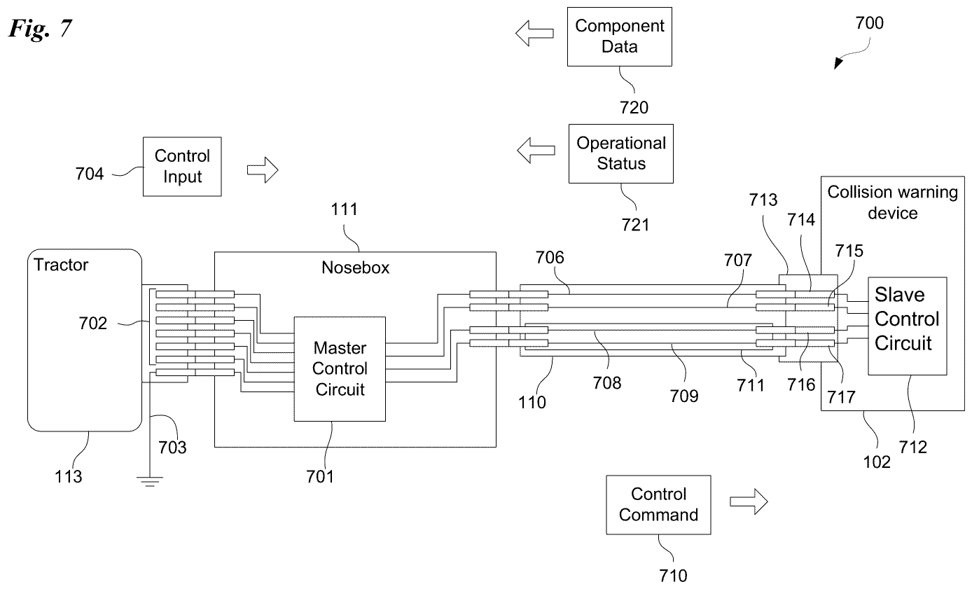

Other aspects of the trailer and the trailer wiring system may operate in cooperation with a rear collision warning device of the present disclosure. As illustrated in FIG. 7 at 700, a nose box of the present disclosure optionally includes a master control circuit 701 that is electrically connected to multiple power terminals 702 of the truck tractor, and to a common ground terminal 703. These multiple individual connection terminals are configured to accept power and/or control input 704 from the truck tractor and thus the multiple connection terminals may be arranged and configured to correspond to trailer connection terminals of the truck. In the example of FIG. 7, the connection terminals include six separate power cable connections 702 and a ground cable connection 703, and the master control circuit may be electrically connected to the seven connection terminals 702, 703. These connection terminals may be included inside the nose box, or they may extend through nose box to engage a cable electrically connecting the connection terminals to the truck tractor.

In one example, the nose box may include a connector and terminals configured to conform to the Society of Automotive Engineers (SAE) J-560 standard. Under the J-560 standard, separate circuits are included in a truck trailer cabling system where each circuit is dedicated to provide power to trailer components during particular modes of operation. For example, a yellow wire may be dedicated to the left turn signal and hazard lamps, a green wire may be dedicated to operate the right turn signal and hazard lamps, and a black wire may be dedicated for clearance side marker and identification lamps. In some situations, multiples of these circuits may be powered by the tractor in order to activate different trailer components they are connected to at the same time. In other situations, one circuit may be selectively powered while others are not. Generally speaking, each circuit in a J-560 power distribution circuit is designed to receive power based on driver input that engages the system to operate in a particular mode of operation (e.g. turn signal to activate flashers, brake pedal pressed to activate brake lights, etc.) In this way control input 704 may be defined by the tractor as it selectively provides power to one or more of separate power cable connections 702.

The master control circuit is optionally configured to accept control input from the tractor via the separate power cable connections and to generate and send control commands 710 for controlling one or more individual trailer components mounted to trailer, one example of which is the rear collision warning device of the present disclosure. In another aspect, the master control circuit may be configured to send control commands to the trailer components via communication cables 708. The master control circuit may also be configured to use on or more optional additional communication cables 709 to send the control commands.

In another aspect, the collision warning device may be operable to send operational status information 721, and/or component data 720 to the master control circuit via the data bus. This may include any relevant information about the collision warning device such as notifications of outages, circuit faults, or other failures in the connectors or cables. In another aspect, the operational status information may include diagnostic or calibration data provided by the rear-facing sensor. The component data 720 may include the distance, relative speed, TTC, collision alerts, or other information obtained or calculated by the collision warning device. This information may be used by the mater control circuit to determine what, if any, actions should be taken. These actions optionally include activating or deactivating other trailer components (e.g. lamps on the back of the trailer, rear-facing trailer cameras, and the like) as the collision warning device provides updates on the vehicles behind the trailer.

In another aspect, trailer wiring system of the present disclosure optionally includes a data bus 711 that may include at least one communication cable 708, and optionally a second communication cable 709, along with the metallic power cable 706, and the metallic ground cable 707. In this configuration, the master control circuit may be configured to generate control commands for controlling the rear-facing sensor and to send the control commands to the rear-facing sensor via the data bus. The control commands may be acted on by a slave control circuit 712 which is optionally included in the collision warning device of the present disclosure.

In another aspect, the rear-facing sensor may be coupled to the metallic power cable and the data bus by a single connector 713 having at least one power terminal 714 electrically connected to the power cable, at least two communication terminals 716 and 717 electrically connected to the data bus, and a ground terminal 715 electrically connected to a metallic ground cable of the wiring system in the trailer.

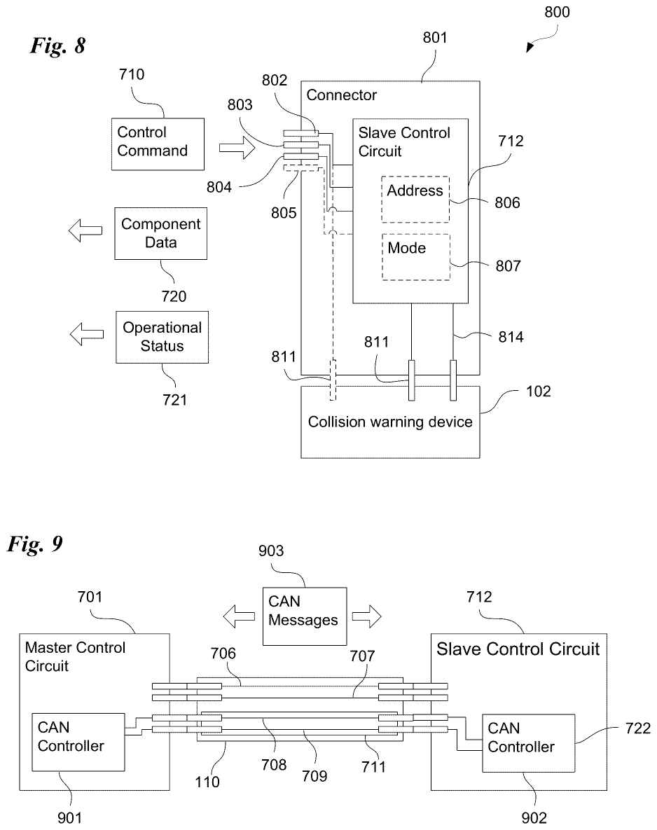

In another aspect, the slave control circuit may be mounted in a connector of the trailer that is arranged and configured to accept trailer components such as a collision warning device. One example of such a trailer connector is shown at 800 in FIG. 8. Trailer connector 801 optionally includes a main power connection 802 that is electrically connected to the metallic power cable of the trailer wiring system, a ground connection that is electrically connected to the ground cable of the trailer wiring system, and at least one communication cable connection 804, and an optional additional communication cable connection 805 optionally electrically connected to communication cables that may be included in the trailer wiring system.

The connector provides a component power connection for the collision warning device or other trailer component via a main power connection terminal 811 which is configured to electrically connect an individual trailer component to the power cable of the trailer wiring system. A component ground connection is provided by ground connection terminal 814 which is configured to electrically connect the individual trailer component to the ground cable of the trailer wiring system.

Electrical connections between the power cable and power connection terminal, and between the ground cable and the ground connection terminal are optionally controlled by the slave control circuit. The slave control circuit is optionally configured to selectively electrically connect the component power connection and the component ground connection to the main power connection or the ground connection, based on input received by the at least one communication cable connection. This allows the slave control circuit to communicate with the master control circuit, and to thus activate, deactivate, or otherwise change the state of, an individual trailer component such as the collision warning device. This may be accomplished by selectively connecting the component power and ground connections of the collision warning device to the main power and/or ground connections.

In another aspect illustrated in FIG. 8, the slave control circuit may be configured to only control the connection from ground connection terminal, while power connection terminal may be continuously connected to the power cable. In this example, the slave control circuit is optionally configured to selectively activate and deactivate the collision warning device by controlling the ground connection portion of the circuit alone.

In another aspect, the main power connection, ground connection, and at least one communication cable connection electrically connects the slave control circuit to the master control circuit which may be mounted in the nose box of the trailer. In this example, the master control circuit is configured to accept control input from the tractor, and is optionally configured to generate different control commands specific to the collision warning device based on control input received from the truck tractor.

In another aspect, slave control circuit may include an address 806 uniquely identifying slave control circuit separately from all other slave control circuits in the trailer. The slave control circuit may maintain an address 806 in a memory such as a nonvolatile memory of the slave control circuit. In another example, the slave control circuit optionally defines an address using an arrangement of mechanical switching devices arranged in a predetermined order. In another aspect, the slave control circuit may be remotely updatable without requiring any physical manipulation to adjust the address.

In another aspect, the slave control circuit may include one or more modes 807 identifying a single mode, or optionally multiple modes, of operation under which the slave control circuit will operate. For example, modes of operation may correspond with driver inputs such as applying input using a brake pedal, turn signal, steering wheel, transmission gear selector, or by providing user input using a user interface such as a touchscreen, buttons, and the like mounted in the operator's compartment of the tractor. These modes of operation may be defined by any suitable means such as by receiving power applied to one of the separate power cable connections at the note box. In one example, some or all slave control circuits in the various connectors mounted to the trailer may be sent the same control command which may include one or more modes. The slave control circuits may receive the same command and compare the modes in the command to the modes stored in the control circuit, and then activate, deactivate, or otherwise change state as required by the detailed instructions in the command when those modes of operation specified in the control commands match the mode stored in slave control circuit.

In another aspect, the slave control circuit 712 optionally includes this address and mode behavior in the case where the slave control circuit is mounted in the collision warning device directly rather than in a connector that the collision warning device is coupled to. The slave control circuit is configured to compare the target mode identifier in the control commands received from the master control circuit with the mode identifier of the slave control circuit, and to activate and deactivate aspects of the rear-facing sensor, or other trailer component, when the target mode identifier matches the mode identifier of the slave control circuit.

In another aspect illustrated in FIG. 9 the master control circuit and the slave control circuit of the present disclosure may communicate using the Control Area Network (CAN) protocol. The trailer wiring system of the present disclosure optionally includes two communication cables. The communication cable 708, may for example, operate as a CAN-high communication cable, and the communication cable 709 may optionally operate as a CAN-low communication cable. The master control circuit optionally includes a CAN master controller 901 electrically connected to the communication cables of the data bus. The master control circuit is thus configured to send control commands to slave control circuits as messages 903 traveling via the CAN transmission protocol. The slave control circuit may include a CAN slave controller 902 also electrically connected to the communication cables of the data bus. In this example, the master control circuit and one or more slave control circuits may optionally communicate using the CAN protocol. In another aspect, the control commands, component data, and operational status passing between the master control circuit and the slave control circuit(s) may be carried across the data bus as message payload within the messages passed back-and-forth according to the CAN messaging protocol.

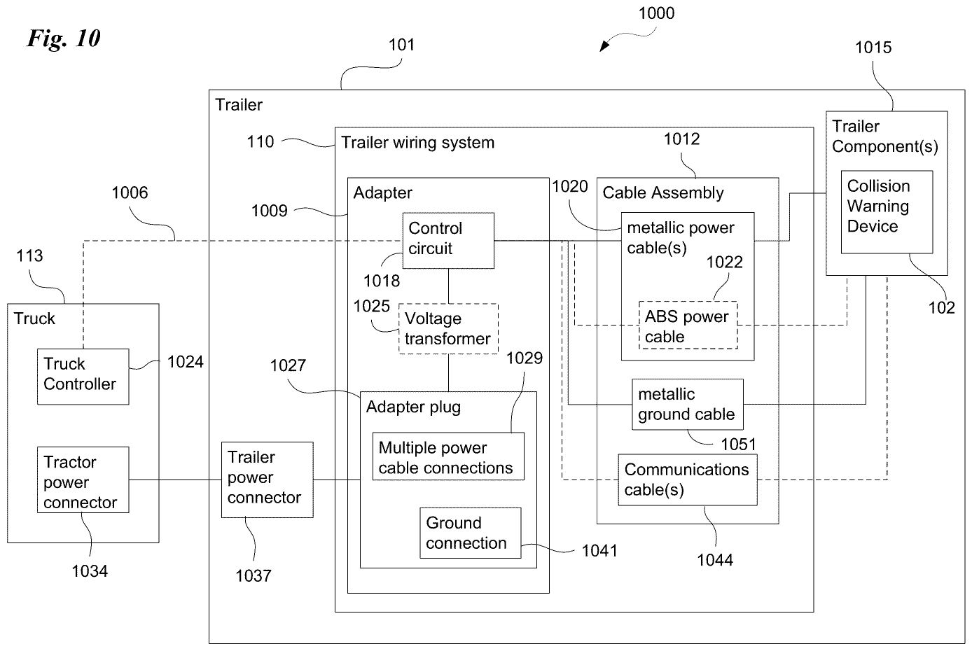

Additional optional aspects of the trailer wiring system of the present disclosure are illustrated in FIG. 10 at 1000. The trailer wiring system of the present disclosure is arranged and configured generally to carry electricity from a trailer power connector 1037 to the trailer components 1015, one of which is the collision warning device of the present disclosure. Along the way, the incoming power received from the truck tractor may be optionally increased in voltage, and adapted for use with a cable assembly 1012 that reduces the size and number of metallic power and/or data cables in the trailer wiring system when compared with a standard seven wire trailer wiring configuration.

Examples of trailer components that may be electrically connected to the trailer wiring system include, but are not limited to, lamps, braking system components, other sensors besides those included in the collision warning device, cameras, and/or a refrigeration system to name a few nonlimiting examples. For example, lamps may include, but are not limited to, running lamps, interior illumination lamps for lighting the interior of the trailer, side marking/clearance/identification lamps for marking extremities of the trailer, backup lamps for illuminating the area behind the trailer, license plate lamps for lighting license plates and other identifying indicia mounted on the trailer, stop or brake lamps that may illuminate when the vehicle is actively braking, tail lamps, left and right turn signal lamps and respectively, and alternatively, combination stop-tail-turn lamps.

Sensors may include any of temperature sensors for sensing the temperature in and/or around trailer, door sensor configured to optionally sense when trailer doors are open or closed, cargo sensor configured to optionally sense weight, location, and/or other attributes of cargo in or on trailer, a humidity sensor for optionally sensing absolute or relative humidity in and/or around trailer, a tank level sensor optionally for sensing the level of fluids (liquids or gases) carried by trailer, proximity sensors optionally for sensing proximity of trailer relative to nearby objects, and/or tire pressure sensors optionally for sensing pressure levels in tires on trailer 101.

Braking system trailer components may optionally include a controller for controlling the ABS braking system, an ABS lamp optionally for indicating the status or failure of the braking system, and/or a pressure sensor optionally included to sense changes in hydraulic or air pressure in braking system. Other optional trailer components include cameras such as one or more backup cameras for optionally capturing a view of the surrounding area directly behind the trailer, and one or more side cameras for optionally capturing a view of areas adjacent the sides of trailer.

Components of a refrigeration system may include a temperature sensor for determining the temperature inside the refrigerated cargo area of the trailer, a controller configure to control the refrigeration cycle in the refrigeration system, and a refrigerant level sensor for determining the level of refrigerant in the system.

The trailer wiring system of the present disclosure may receive power from the trailer power connector, which may be electrically connected to a corresponding tractor power connector 1034. This initial electrical connection from the tractor to the trailer may include any suitable number of wires such as 2 or more, 4, 5, or 6 wires, or 7 or more wires. For example, the tractor and trailer may be electrically connected using an industry standard power cable having an SAE J-560 7-wire trailer power connector on each end. A J-560 power connecter on one end of the cable may be, for example, inserted into the tractor power connector, and the J-560 power connecter on the other end of the cable may be inserted into the trailer power connector.

The trailer power connector may be electrically connected to an adapter 1009 optionally included in the trailer wiring system. The adapter may include an adapter plug 1027 having multiple power cable connection terminals 1029 and a ground connection 1041, the multiple power cable connections and the ground connection corresponding to trailer connection terminals of the truck tractor. For example, the trailer power connector may have the seven connection terminals corresponding to the pins in a J-560 power connector, including a ground cable connection and six separate power cable connections illustrated in FIG. 7. The adapter plug may have seven connection terminals corresponding to these or other terminals in the trailer power connector. Terminals in the trailer power connector optionally correspond to connection terminals in the tractor power connecter. In this way, electricity or electrical signals may be received from the truck by the trailer wiring system.

The adapter may provide power and/or transfer electrical signals to and from the trailer wiring system of the present disclosure. For example, the trailer wiring system may include a cable assembly 1012 with one or more metallic power cables 1020 electrically connected to the trailer components collision warning device. The power cables may include certain power cables specific to particular systems or subsystems of the trailer. For example, the cable assembly optionally includes a power cable 1022 dedicated to provide Antilock Brake System (ABS) power and/or electrical signals to ABS related trailer components. The cable assembly may also include a metallic ground cable 1051 and optionally zero or more communication cables 1044 of the present disclosure that are configured to send and receive signals representing data and/or control signals passed to and from trailer components of the trailer. The cable assembly may thus be composed of separate metallic cables of any suitable length such as greater than 5 m long, 10 m long, or greater than 30 m long.

In another aspect, a control circuit 1018 may be included in adapter 109 and optionally configured to selectively electrically connect and disconnect metallic power cables 1020, metallic ground cable 1051, and the optional communication cable or cables 1044. Control circuit 1018 may be configured to send and/or receive communications signals from a plurality of the multiple components of the truck trailer using any suitable combination of cables in cable assembly 1012.

Control messages or signals may be sent from a control circuit 1018. In another aspect, the status operational messages, or other signals sent by the collision warning device and/or other trailer components may be received by the control circuit. For example, the control circuit 1018 may send an activation message to the collision warning device, to a backup camera trailer component, to a turn signal, running lamp, and the like. The backup camera may begin capturing video imagery from behind the trailer. The captured video imagery may then be passed back to the control circuit as operational messages or signals providing the control circuit with access to real-time video imagery. Status information, as well as operational data (e.g. a video feed, or distance and TTC data), may optionally be provided to the truck by the control circuit using an optional additional communications link such as link 1006. The control circuit 1018 may also use the communication link with the truck to communicate directly with the truck's internal computer or controller 1024 such as in the case of communicating with the trucks Electronic Control Unit (ECU). This link may be implemented as a wireless connection using any suitable wireless transmission technology, or as a wired connection using an additional data cable connected to an optional data port on the tractor.

In one aspect, the collision warning device may be operable to send a collision warning message or signal to the control circuit 1018 as discussed herein elsewhere via the communication cables 1044. This communication may, as disclosed herein, occur using the CAN messaging protocol, or by any other suitable method of communication. The control circuit 1018 in the trailer wiring system, in the nose box for example, may communicate with the truck controller 1024 to notify the truck that a collision warning has been sent by the collision warning device.

The truck controller may be operable to respond in any suitable manner. In one example, the truck controller may activate an operator indicator in the cab such as a buzzer, lamp, or warning message displayed on a display device in the cab. A computer, such as a smartphone, tablet, or other computing device may be sent a warning message and the driver may be notified by a corresponding indication of a collision warning on a display device of the computer.

In another example, the truck controller may activate one or more vehicle systems that might be useful in reducing or eliminating the risk of collision, or may be helpful in mitigating the damage or injury to the occupants should a rear-end collision occur. In one aspect, the truck controller may be configured to automatically reduce braking pressure, or to release the brakes entirely in response to receiving notification of a collision warning. In another aspect, the truck controller may be configured to automatically apply the accelerator to reduce or eliminate the likelihood of a collision, or to at least reduce the speed differential between the following vehicle and the trailer. In another aspect the truck controller may be configured to automatically activate belt tensioning aspects of the seat belts in the truck thus reducing or eliminating the opportunity for injury to the occupants of the truck, if any are present. These and other similar responses may be included as part of the programming or configuration of the truck controller, or of some other aspect of the truck, such as an autonomous control system of the truck. An autonomous control system may be in constant communication with the control circuit in the trailer, or with the collision warning device directly, and warning received from the collision warning device may be used to trigger these and possibly other responses by the truck to reduce the risk of rear-end collisions, or to reduce the harm caused by them.

An optional voltage transformer 1025 may be included in the adapter. The voltage transformer may be configured to increase the voltage provided by the multiple power cable connections and to deliver the increased voltage to the power cables of the cable assembly. The voltage transformer is optionally electrically connected to the metallic power cable(s), and to the power terminals of the multiple power cable connections.

The control circuit 1018 may be configured as a “master” node configured to send signals representing triggering data, commands, messages, or control signals to the collision warning device and to other trailer components, and to receive and process status or operational information sent from any or all of these trailer components as well. Such status information may include whether the trailer component is working properly, whether specific internal aspects of the trailer component have failed including information about which aspects are involved. Such status information may include outage of a lamp, camera malfunction, sensor failure, and the like. When the control circuit is configured as a “master”, the trailer components may be individually configured as separate, “slave” nodes as discussed herein elsewhere that receive and respond to instructional or control signals sent from the master, and that also send status information or other data to the master node.

As discussed herein elsewhere, the trailer wiring system includes, a single power cable, a single ground cable, and two communications cables. The cables discussed herein that are part of the trailer wiring system, cable assemblies, data bus, and so forth, may be implemented with wire of various sizes to advantageously reduce the overall wire usage for the trailer. For example, the power cable and ground cable may have a cross-sectional area less than or equal to an 8 AWG cable, which is to say each may have a cross-sectional area of 8.4 mm². The communications cables may have a cross-sectional area less than or equal to 18 AWG cable, which is to say these cables may have a cross-sectional area of up to 0.823 mm² each. In this example, up to 40 A of current may be provided by the power cable at about 12 V resulting in up to about 480 W of available power but with a 43% reduction in the metallic material used as compared to a conventional J-560 compliant trailer wiring system with seven wires.

In another example, the optional voltage transformer may be configured to increase the voltage on the power cable from, for example, 12 V to 24 V. By increasing the voltage, a similar amount of power may be provided but with less current than what may be found in a conventional J-560 compliant trailer wiring system. In this example, the power cable and the ground cables of the present disclosure may have a cross-sectional area less than or equal to 12 AWG cable, which is to say each may have a cross-sectional area of up to 3.3 mm². In this example, up to 20 A of current may be provided at about 24 V resulting in up to about 480 W of available power but with a 74 % reduction in the metallic material used as compared to a conventional J-560 compliant trailer wiring system with seven wires.

In another example, the voltage transformer may increase the voltage on the power cable from, for example, 12 V to 48 V. In this example, up to 10 A of current may be provided at about 48 V resulting in up to about 480 W of available power but with a 90% reduction in the metallic material used as compared to a conventional J-560 compliant trailer wiring system with seven wires.

The truck trailer wiring system thus optionally includes a metallic ground cable, a metallic power cable, and a data bus of the present disclosure having at least one metallic communications cable. An aggregate cross-sectional area of the metallic power cable, the metallic ground cable, and each of the metallic communications cable when present, is optionally at least ten percent (10%) less than the about 32 mm² present in a conventional J-560 compliant trailer wiring system calculated as the aggregate of:
(i) four metallic 12 AWG cables each with a cross-sectional area of about 3.3 mm²,
(ii) two metallic 10 AWG cables each with a cross-sectional area of about 5.3 mm²,
(iii) one metallic 8 AWG cables each with a cross-sectional area of about 8.4 mm²,
Totaling the about 32 mm² in aggregate cross-sectional area of metallic cable

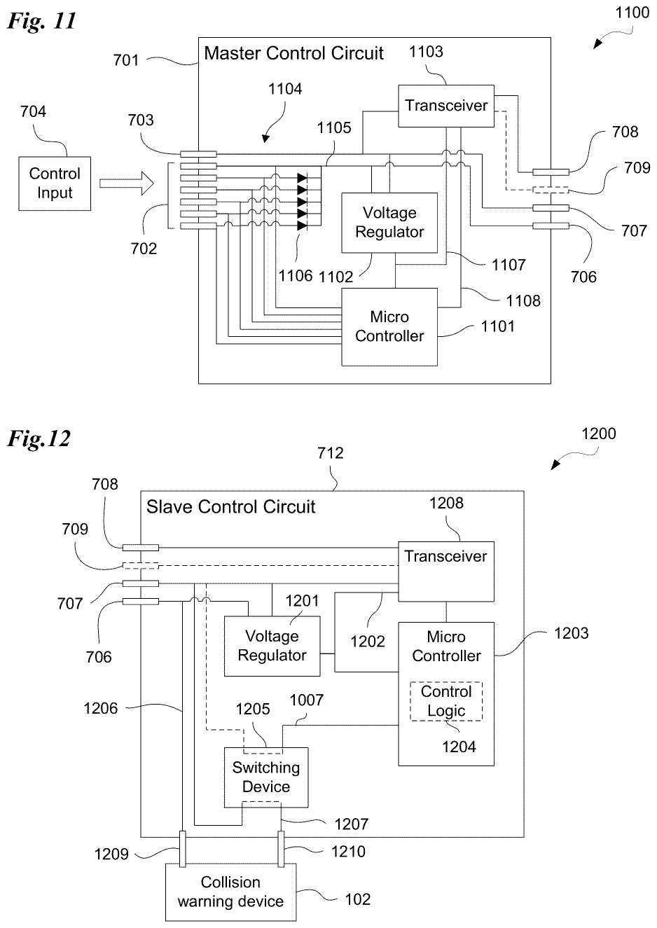

Illustrated in FIG. 11 at 1100, a master control circuit of the present disclosure optionally includes a master microcontroller 1101 electrically connected to a voltage regulator 1102 and a master transceiver 1103. In this example, the multiple separate power cable connections provided by the multiple power terminals are combined at a power junction 1104 to provide power to the master control circuit on a power cable 1105, while a connection to the common ground terminal provides a ground circuit connection for the components of the control circuit. In this example, 702 and 703 provide seven separate connections (e.g. representing seven connections of a standard J-560 power cable), six of which are coupled to power cable 1105. The diode array may be included to reduce or eliminate return currents flowing in the opposite direction from each separate power cable connection to another.

Power and ground connections within the master control circuit are provided by the voltage regulator and the ground connection. Trailer components, including the rear collision device, that are downstream from the master control circuit, optionally receive power via the power cable 1105 and 706 and are connected to a common circuit ground via ground cable 707. A power circuit 1107 electrically connects power output from the voltage regulator to the master transceiver and the master microcontroller 1101. The power circuit 1107 may be included to provide regulated voltage and/or current to the microcontroller and transceiver of the master control circuit, and possibly to other circuits as well. For example, devices in the circuit may operate on 5 V, 3.3 V, or 12 V, or some other voltage, while power provided from the multiple power terminals bringing power into the master control circuit may be provided at 6 V, 12 V, 24 V, 48 V, or possibly other higher or lower voltages.

The communication cables optionally electrically connect the master microcontroller and transceiver to multiple slave transceivers in trailer components downstream from the master control circuit. In the case of a 4-wire trailer wiring system such as might use a CAN implementation discussed above, the communication cables optionally correspond to or operate as CAN-high and CAN-low cables.

Operational control of the master control circuit may be provided by the master microcontroller. The master microcontroller sends control signals on a master I/O circuit 1108 to other components such as the master transceiver. The control input is optionally provided to the master control circuit via the separate power cable connection terminals. Such control input includes, but is not limited to changes in voltage, changes in current levels, or as time varying signals for carrying digital or analog data to the master control circuit.

The power junction at 1104 aggregates power provided by the separate power cable connections, but also provides the master microcontroller with separate inputs for each separate power cable connection so that the master microcontroller can be configured to detect different operating modes of the truck tractor and trailer based on different power levels on the separate power connection terminals, or by any other suitable means. The connection terminals thus operate as control inputs indicating actions to be taken by the various trailer components optionally including the collision warning device.

FIG. 12 illustrates at 1200 additional components that may be included in a slave control circuit of the present disclosure. The slave control circuit optionally receives power from power cable 706 and ground cable 707 providing power and ground connections respectively to the components of the slave control circuit. A voltage regulator 1201 may be included to regulate the voltage provided via a power circuit 1202 according to the needs of a slave microcontroller 1203 and optionally some or all of the other components in the circuit such as control logic 1204, and a slave transceiver 1208. For example, the microcontroller may require 5 V, 3.3 V, or 12 V, or some other suitable voltage while power provided by the power cable may be provided at 12V, 24 V, 48 V, or possibly at other higher or lower voltages.

A switching device 1205 may be included and may be responsive to signals from the slave microcontroller and is optionally configured to control the flow of power from the power cable to the collision warning device or other trailer component coupled to the slave control circuit. For example, the switching device may include a relay configured as shown in FIG. 10 with a constant connection to the power cable being provided to the collision warning device via component power circuit 1206 and a power connection terminal 1209, and a ground connection selectively provided by component activation circuit 1207 by a ground connection terminal 1210, a ground circuit electrical connection that is made based on a control output from the component control output circuit. In another aspect, the switching device may include a solid state switching device without internal physical moving parts that is configured to accept input from the component control output circuit and to selectively electrically connect the collision warning device to ground.

In another aspect, the slave microcontroller may be configured to separately signal the collision warning device to activate or deactivate one or more functions or features separately from the aspect of supplying or disconnecting power. The microcontroller optionally receives message data from the transceiver when a control message is sent by the master controller and received by the transceiver The slave control circuit may include the control logic 1204 which may optionally be programmed to differentiate the role of the collision warning device from that of the other individual trailer components. This role may be configured by specifying one or more operating modes the slave control circuit should respond to, or by specifying an address that uniquely identifies the slave control circuit (and any trailer components it is coupled too).

For example, the slave microcontroller may optionally include control logic programmed or otherwise configured to operate trailer components such as the collision warning device. In another example, the control logic is optionally configured or programmed to respond only to control commands that include an address identifier that matches the address of a particular slave control circuit. In this example, one or more trailer components may respond as a group based on an address of each slave control unit address specified in the command. In this example, the specific action to take may be defined by the type of message (e.g. “brake activation” message, “camera off” message, “software upgrade” message). As disclosed herein elsewhere, the collision warning device optionally includes a slave control circuit of the present disclosure, or, the slave control circuit may be positioned within a socket or connector that the collision warning device is connectable to either physically, electrically, or both.

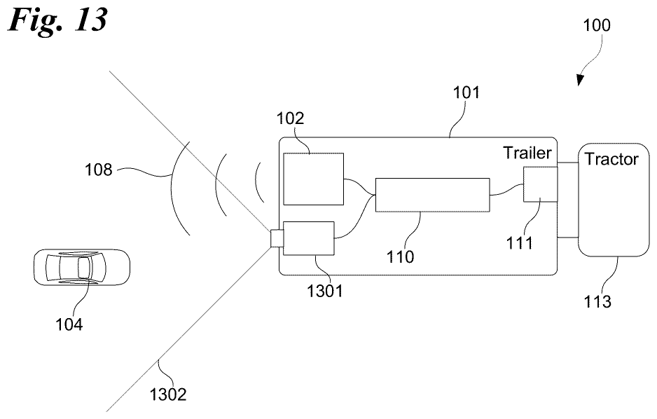

In another aspect, a trailer of the present disclosure may optionally include a camera for capturing video, or still images, of the area behind the trailer. As illustrated in FIG. 13, trailer of the present disclosure optionally includes a camera 1301 defining a field of view 1302 that includes the area behind the trailer. This may be a rear-facing camera mounted at the rear of the trailer, such as an existing backup camera or surveillance camera. In another aspect, the camera is optionally responsive to control commands from the nose box received via the data bus of the trailer wiring system. The camera is optionally operable to activate in response to a collision warning sent by the control circuit. For example, the collision warning device may determine that a collision may soon happen by any suitable criteria, and may activate the camera by any suitable means. In one example, the collision warning device may send a collision warning to the master control circuit, and the master control circuit may then send a message to the camera, or to a connector the camera is coupled to thus indicating that camera should be activated. The camera may then proceed to capture video or still images of the field-of-view behind the trailer, preferably before, during, and after the collision, or new collision, takes place. The camera optionally captures a field of view that includes the area behind the trailer, wherein the camera is responsive to the control circuit, wherein the camera is operable to capture imagery when the control circuit triggers a collision warning.

In another aspect, the camera may be positioned inside a housing that also includes the collision warning device, such as in the case of the collision warning device illustrated in FIG. 6. In this configuration, the camera may be activated directly by the control circuit of the collision warning device rather than by a master control circuit in the nose box of the trailer.

In accordance with some forms disclosed herein, the collision warning device may include sensors that are strategically positioned along the sides of a vehicle. This side placement of sensors is particularly advantageous for enhancing safety during specific maneuvers, such as when a commercial vehicle is backing into a loading dock. During such operations, a portion of the vehicle often protrudes into the roadway, perpendicular to the direction of travel, creating a significant risk of T-bone collisions with oncoming traffic that may not be visible to the driver or detectable by rear-facing sensors alone. By positioning sensors on the sides of the vehicle, the detection zone is expanded to cover lateral approaches, enabling the control circuit to detect vehicles or objects approaching from the sides and to trigger appropriate warnings to mitigate the risk of side-impact collisions.

The side-mounted sensors, which may utilize electromagnetic energy in a frequency range between 100 MHz and 100 PHz (such as radar or lidar as described herein), are configured to define lateral detection zones extending outwardly from the sides of the vehicle. These sensors communicate with the control circuit, which is adapted to process data from both rear and side sensors to determine collision parameters such as time to collision, distance, and closure rate for vehicles approaching from multiple directions. When a potential collision is detected from the side, the control circuit can activate warning indicators—such as flashing lamps, strobes, or audible alarms—directed towards the approaching vehicle, as well as notify the driver via the cab-mounted operator indicator. This multi-directional detection capability significantly enhances situational awareness and safety, particularly in high-risk scenarios like loading dock maneuvers where visibility is often limited.

Additionally, the side-mounted sensors may be integrated into the same housing as the rear-facing sensors or provided in separate housings mountable along the sides of the vehicle, ensuring flexibility in installation and compatibility with various vehicle designs. The control circuit can be programmed with specific triggering criteria for side-impact warnings, which may differ from rear collision thresholds due to the unique dynamics of lateral collisions. For instance, the criteria may account for shorter reaction times in T-bone scenarios and activate warnings at different time-to-collision thresholds or intensify warning signals sooner.

The concepts illustrated and disclosed herein may be arranged and configured according to any of the following non-limiting numbered examples:

Example 1: A collision warning device for a truck trailer that includes a rear-facing sensor defining a detection zone behind the trailer, wherein the rear-facing sensor is operable to detect a following vehicle behind the trailer.

Example 2: The collision warning device of any other example, including a control circuit responsive to the rear-facing sensor, wherein the control circuit is configured to determine a collision parameter.

Example 3: The collision warning device of any other example, wherein a collision parameter includes a time to collision.

Example 4: The collision warning device of any other example, wherein a collision parameter includes a time to collision.

Example 5: The collision warning device of any other example, wherein a collision parameter includes a distance between the sensor and the following vehicle.

Example 6: The collision warning device of any other example, wherein a collision parameter includes a closure rate between the sensor and the following vehicle; and (d) combinations thereof.

Example 7: The collision warning device of any other example, wherein the control circuit is configured to determine a collision parameter selected from the group consisting essentially of: (a) time to collision; (b) distance between the sensor and the following vehicle; (c) closure rate between the sensor and the following vehicle; and (d) combinations thereof.

Example 8: The collision warning device of any other example, including a rear-facing warning device responsive to the control circuit.

Example 9: The collision warning device of any other example, including a rear-facing warning device that is operable to emit a warning signal toward a following vehicle.

Example 10: The collision warning device of any other example, wherein the sensor communicates with a trailer nose box via a data bus in the trailer.

Example 11: The collision warning device of any other example, wherein the warning device receives power from a metallic power cable of the trailer that provides more than 18 volts to the sensor.

Example 12: The collision warning device of any other example, wherein the rear-facing sensor and the rear-facing warning device are mounted adjacent the rear of the trailer.

Example 13: The collision warning device of any other example, wherein the data bus is a CAN bus.

Example 14: The collision warning device of any other example, wherein the power cable of the trailer provides more than 24 V to the sensor.

Example 15: The collision warning device of any other example, wherein the rear-facing sensor is operable to detect a distance from the truck trailer to the following vehicle.

Example 16: The collision warning device of any other example, wherein the rear-facing sensor is operable to detect he speed of the following vehicle.

Example 17: The collision warning device of any other example, wherein the control circuit is operable to determine a speed differential based on input received from the rear-facing sensor.

Example 18: The collision warning device of any other example, wherein the speed differential is defined as a difference in speed between the truck trailer and the following vehicle.

Example 19: The collision warning device of any other example, wherein the warning device includes an amber lamp, a red lamp, or any combination thereof.

Example 20: The collision warning device of any other example, wherein the triggering criteria include predetermined thresholds specifying a first warning when the time to collision is less than six seconds, a second different warning when the time to collision is less than four seconds, and a third different warning when the time to collision is less than two seconds.

Example 21: The collision warning device of any other example, wherein the control circuit activates one or more amber lamps of the warning device when the first warning is triggered, one or more red lamps of the warning device when the second warning is triggered, and one or more red and amber lamps of the warning device when the third warning is triggered.

Example 22: The collision warning device of any other example, wherein lamps of the warning device are activated at a first intensity for the first warning, at a second higher intensity for the second warning, and at third intensity for the third warning that is higher than the first or second intensities.

Example 23: The collision warning device of any other example, including an operator indicator mounted in a cab of the truck coupled to the trailer, and wherein the operator indicator is responsive to the control circuit to display a warning for the driver of the truck when the collision warning is triggered.

Example 24: The collision warning device of any other example, wherein the operator indicator includes a computer that is operable to display a notification received by the computer, and wherein the computer is operable to receive collision warning notifications sent by the control circuit when a collision warning is triggered.

Example 25: The collision warning device of any other example, wherein the control circuit is configured to send collision warning notifications to the remote server via that data bus electrically connected to a communications interface in the trailer nose box.

Example 26: The collision warning device of any other example, wherein the rear-facing sensor emits electromagnetic energy to detect the following vehicle that has a frequency ranging between 100 MHz and 100 PHz.

Example 27: The collision warning device of any other example, wherein the truck trailer includes a metallic ground cable, the data bus includes at least one metallic communications cable, and an aggregate cross-sectional area of the metallic power cable, the metallic ground cable, and each of the metallic communications cable when present, is at least ten percent (10%) less than the about 32 mm² present in a conventional J-560 compliant trailer wiring system calculated as the aggregate of: four metallic 12 AWG cables each with a cross-sectional area of about 3.3 mm², two metallic 10 AWG cables each with a cross-sectional area of about 5.3 mm², and one metallic 8 AWG cables each with a cross-sectional area of about 8.4 mm², totaling the about 32 mm² in aggregate cross-sectional area of metallic cable.

Example 28: The collision warning device of any other example, wherein the rear-facing sensor is coupled to the metallic power cable and the data bus by a single connector having at least one power terminal electrically connected to the power cable, at least two communication terminals electrically connected to the data bus, and a ground cable electrically connected to a metallic ground cable of the truck trailer.

Example 29: The collision warning device of any other example, wherein the nose box includes a master control circuit that is electrically connected to multiple power terminals of a truck tractor, the metallic power cable, and a metallic ground cable.

Example 30: The collision warning device of any other example, wherein the data bus includes at least one communication cable.

Example 31: The collision warning device of any other example, wherein the master control circuit is configured to generate control commands for controlling the rear-facing sensor and to send the control commands to the rear-facing sensor via the data bus.

Example 32: The collision warning device of any other example, wherein the trailer includes a trailer component connector that is electrically connected to the power, ground, and the at least one communication cable.

Example 33: The collision warning device of any other example, wherein the trailer component connector includes a slave control circuit that is configured to receive the control commands sent by the master control circuit and to selectively control the rear-facing sensor according to the control commands.

Example 34: The collision warning device of any other example, wherein the slave control circuit includes a mode identifier, and the control commands sent by the master control circuit include a target mode identifier.

Example 35: The collision warning device of any other example, wherein the slave control circuit is configured to compare the target mode identifier in the control commands with the mode identifier of the slave control circuit, and to activate and deactivate aspects of the rear-facing sensor when the target mode identifier matches the mode identifier of the slave control circuit.

Example 36: The collision warning device of any other example, wherein the trailer includes a camera defining a field of view that includes the area behind the trailer.

Example 37: The collision warning device of any other example, wherein the camera is responsive to control commands from the nose box received via the data bus.

Example 38: The collision warning device of any other example, wherein the camera is operable to activate in response to a collision warning sent by the control circuit.

Example 39: The collision warning device of any other example, wherein the camera is electrically connected to the data bus and is operable to activate in response to control commands sent from the nose box and received via the data bus.

Example 40: The collision warning device of any other example, wherein the nose box is configured to send a control command activating the camera in response to a collision warning received from the control circuit.

Example 41: The collision warning device of any other example, wherein the control circuit is configured to send a control command activating the camera when a collision warning is sent.

Example 42: The collision warning device of any other example, wherein the camera is responsive to collision warning messages sent by the control circuit via the data bus and is configured to activate when a collision warning message is received.

Example 43: The collision warning device of any other example, including a control circuit responsive to the sensor, wherein the control circuit is configured to determine a time to collision for the following vehicle, to compare the time to collision to triggering criteria, and to trigger a collision warning when the triggering criteria are satisfied.

Example 44: The collision warning device of any other example, including a warning indicator facing the rear direction that is responsive to the control circuit, wherein the warning indicator has one or more lamps that are arranged and configured to emit a warning signal away from the rear of the trailer, wherein the triggering criteria include predetermined thresholds specifying activation of one or more amber lamps when the time to collision is less than six seconds, activation of one or more red lamps when the time to collision is less than four seconds, and activation of the one or more red and amber lamps when the time to collision is less than two seconds.

Example 45: The collision warning device of any other example, including a housing containing the sensor, the warning indicator, the one or more lamps, and the control circuit, wherein the housing is mountable at the rear of the trailer.

Example 46: The collision warning device of any other example, wherein the cab warning device is responsive to the control circuit, wherein the cab warning device is located in a cabin of a vehicle coupled to the trailer, and wherein the control circuit is configured to activate the cab warning device when a collision warning is triggered.

Example 47: The collision warning device of any other example, including a camera defining a field of view that includes the area behind the trailer, wherein the camera is responsive to the control circuit, wherein the camera is operable to capture imagery when the control circuit triggers a collision warning, and wherein the camera is mounted inside the housing of the collision warning device.

Example 48: The collision warning device of any other example, wherein the red and amber lamps are mounted in the housing.

Example 49: The collision warning device of any other example, including one or more red, white, or amber strobe lamps operable to flash in response to a collision warning generated by the control circuit, wherein the one or more strobe lamps are mounted in the housing.

### GLOSSARY OF DEFINITIONS AND ALTERNATIVES

While examples of the inventions are illustrated in the drawings and described herein, this disclosure is to be considered as illustrative and not restrictive in character. The present disclosure is exemplary in nature and all changes, equivalents, and modifications that come within the spirit of the invention are included. The detailed description is included herein to discuss aspects of the examples illustrated in the drawings for the purpose of promoting an understanding of the principles of the inventions. No limitation of the scope of the inventions is thereby intended. Any alterations and further modifications in the described examples, and any further applications of the principles described herein are contemplated as would normally occur to one skilled in the art to which the inventions relate. Some examples are disclosed in detail, however some features that may not be relevant may have been left out for the sake of clarity.

Where there are references to publications, patents, and patent applications cited herein, they are understood to be incorporated by reference as if each individual publication, patent, or patent application were specifically and individually indicated to be incorporated by reference and set forth in its entirety herein.

Singular forms “a”, “an”, “the”, and the like include plural referents unless expressly discussed otherwise. As an illustration, references to “a device” or “the device” include one or more of such devices and equivalents thereof.

Directional terms, such as “up”, “down”, “top” “bottom”, “fore”, “aft”, “lateral”, “longitudinal”, “radial”, “circumferential”, etc., are used herein solely for the convenience of the reader in order to aid in the reader's understanding of the illustrated examples. The use of these directional terms does not in any manner limit the described, illustrated, and/or claimed features to a specific direction and/or orientation.

Multiple related items illustrated in the drawings with the same part number which are differentiated by a letter for separate individual instances, may be referred to generally by a distinguishable portion of the full name, and/or by the number alone. For example, if multiple “laterally extending elements” 90A, 90B, 90C, and 90D are illustrated in the drawings, the disclosure may refer to these as “laterally extending elements 90A-90D,” or as “laterally extending elements 90,” or by a distinguishable portion of the full name such as “elements 90”.

The language used in the disclosure are presumed to have only their plain and ordinary meaning, except as explicitly defined below. The words used in the definitions included herein are to only have their plain and ordinary meaning. Such plain and ordinary meaning is inclusive of all consistent dictionary definitions from the most recently published Webster's and Random House dictionaries. As used herein, the following definitions apply to the following terms or to common variations thereof (e.g., singular/plural forms, past/present tenses, etc.):

“About” with reference to numerical values generally refers to plus or minus 10% of the stated value. For example, if the stated value is 4.375, then use of the term “about 4.375” generally means a range between 3.9375 and 4.8125.

“Activate” generally is synonymous with “providing power to”, or refers to “enabling a specific function” of a circuit or electronic device that already has power.

“Alert” generally refers to an audible and/or visual message intended to inform a system's users or administrators about a change in the operating conditions of the system or about an error condition of the system. In a graphical user interface, the alert may be displayed as a small window containing a message and/or photo detailing the alert information and parameters. In some examples, the alert may include a button (virtual or physical) to click in order to dismiss the alert. In other examples, the alert may be strictly audible and based on preset parameters. In a further example, the alert may be transmitted to a remote device for analysis. Other synonymous terms for alert include alarm and/or notification.

“And/or” is inclusive here, meaning “and” as well as “or”. For example, “P and/or Q” encompasses, P, Q, and P with Q; and, such “P and/or Q” may include other elements as well.

“Anti-lock Braking System” generally refers to a vehicle safety system that allows the wheels on a motor vehicle (including trailers) to maintain tractive contact with the road surface according to driver inputs while braking, preventing the wheels from locking up (ceasing rotation) and avoiding uncontrolled skidding. ABS systems automatically apply the principles of threshold braking and cadence braking albeit a much faster rate and with better control than drivers can typically manage manually. ABS systems include wheel speed sensors to detect reduced wheel rotation indicative of impending wheel lock. An ABS controller is also included that can automatically actuate the braking system to reduce braking force on the affected wheel or wheels, and to quickly reapply braking force when the danger of wheel lock is reduced. This overall feedback loop may be executed multiple times a second resulting in rapid activation and deactivation of braking force or “pulsing” of the brakes. Maximum braking force is obtained with approximately 10-20% slippage between the braked wheel's rotational speed and the road surface. Beyond this point, rolling grip diminishes rapidly and sliding friction provides a greater proportion of the force that slows the vehicle. Due to local heating and melting of the tires, the sliding friction can be very low. When braking at, or beyond, the peak braking force, steering input is largely ineffective since the grip of the tire is entirely consumed in braking the vehicle. Threshold braking seeks to obtain peak friction by maintaining the maximum braking force possible without allowing wheels to slip excessively. Braking beyond the slipping point causes tires to slide and the frictional adhesion between the tire and driving surface is thus reduced. The aim of threshold braking is to keep the amount of tire slip at the optimal amount, the value that produces the maximum frictional, and thus braking force. When wheels are slipping significantly (kinetic friction), the amount of friction available for braking is typically substantially less than when the wheels are not slipping (static friction), thereby reducing the braking force. Peak friction occurs between the static and dynamic endpoints, and this is the point that threshold braking tries to maintain. “Cadence” braking or “stutter” braking involves pumping the brake pedal and is used to allow a car to both steer and brake on a slippery surface. ABS systems generally provide this behavior automatically and at a much higher rate than most drivers can manually produce. It is used to effect an emergency stop where traction is limited to reduce the effect of skidding from road wheels locking up under braking. This can be a particular problem when different tires have different traction, such as on patchy ice for example. Cadence braking maximizes the time for the driver to steer around the obstacle ahead, as it allows the driver to steer while slowing. ABS generally offers improved vehicle control and decreases stopping distances on dry and slippery surfaces; however, on loose gravel or snow-covered surfaces, ABS can significantly increase braking distance, although still improving vehicle steering control.

“Brake Lamp” generally refers to a lamp (usually red) attached to the rear of a vehicle that illuminates when the brakes are applied to serve as a warning to fellow drivers. As used herein, the term “brake lamp” includes stop lamps as that term is defined under the present legal and/or regulatory requirements for a truck or a trailer such as illuminated surface area, candela, and otherwise. Such regulations include, for example, Title 49 of the U.S. Code of Federal Regulations, section 571.108, also known as Federal Motor Vehicle Safety Standard (FMVSS) 108.

“Cable” generally refers to one or more elongate strands of material that may be used to carry electromagnetic or electrical energy. A metallic or other electrically conductive material may be used to carry electric current. In another example, strands of glass, acrylic, or other substantially transparent material may be included in a cable for carrying light such as in a fiber-optic cable. A cable may include connectors at each end of the elongate strands for connecting to other cables to provide additional length. A cable is generally synonymous with a node in an electrical circuit and provides connectivity between elements in a circuit but does not include circuit elements. Any voltage drop across a cable is therefore a function of the overall resistance of the material used.

A cable may include a sheath or layer surrounding the cable with electrically non-conductive material to electrically insulate the cable from inadvertently electrically connecting with other conductive material adjacent the cable.

A cable may include multiple individual component cables, wires, or strands, each with, or without, a non-conductive sheathing. A cable may also include a non-conductive sheath or layer around the conductive material, as well as one or more layers of conductive shielding material around the non-conductive sheath to capture stray electromagnetic energy that may be transmitted by electromagnet signals traveling along the conductive material of the cable, and to insulate the cable from stray electromagnetic energy that may be present in the environment the cable is passing through. Examples of cables include twisted pair cable, coaxial cable, “twin-lead”, fiber-optic cable, hybrid optical and electrical cable, ribbon cables with multiple side-by-side wires, and the like.

“Computer” generally refers to any computing device configured to compute a result from any number of input values or variables. A computer may include a processor for performing calculations to process input or output. A computer may include a memory for storing values to be processed by the processor, or for storing the results of previous processing.

A computer may also be configured to accept input and output from a wide array of input and output devices for receiving or sending values. Such devices include other computers, keyboards, mice, visual displays, printers, industrial equipment, and systems or machinery of all types and sizes. For example, a computer can control a network or network interface to perform various network communications upon request. The network interface may be part of the computer, or characterized as separate and remote from the computer.

A computer may be a single, physical, computing device such as a desktop computer, a laptop computer, or may be composed of multiple devices of the same type such as a group of servers operating as one device in a networked cluster, or a heterogeneous combination of different computing devices operating as one computer and linked together by a communication network. The communication network connected to the computer may also be connected to a wider network such as the internet. Thus a computer may include one or more physical processors or other computing devices or circuitry, and may also include any suitable type of memory.

A computer may also be a virtual computing platform having an unknown or fluctuating number of physical processors and memories or memory devices. A computer may thus be physically located in one geographical location or physically spread across several widely scattered locations with multiple processors linked together by a communication network to operate as a single computer.

The concept of “computer” and “processor” within a computer or computing device also encompasses any such processor or computing device serving to make calculations or comparisons as part of the disclosed system. Processing operations related to threshold comparisons, rules comparisons, calculations, and the like occurring in a computer may occur, for example, on separate servers, the same server with separate processors, or on a virtual computing environment having an unknown number of physical processors as described above.

A computer may be optionally coupled to one or more visual displays and/or may include an integrated visual display. Likewise, displays may be of the same type, or a heterogeneous combination of different visual devices. A computer may also include one or more operator input devices such as a keyboard, mouse, touch screen, laser or infrared pointing device, or gyroscopic pointing device to name just a few representative examples. Also, besides a display, one or more other output devices may be included such as a printer, plotter, industrial manufacturing machine, 3D printer, and the like. As such, various display, input and output device arrangements are possible.

Multiple computers or computing devices may be configured to communicate with one another or with other devices over wired or wireless communication links to form a network. Network communications may pass through various computers operating as network appliances such as switches, routers, firewalls or other network devices or interfaces before passing over other larger computer networks such as the internet. Communications can also be passed over the network as wireless data transmissions carried over electromagnetic waves through transmission lines or free space. Such communications include using WiFi or other Wireless Local Area Network (WLAN) or a cellular transmitter/receiver to transfer data.

“Communication System” generally refers to an arrangement of cooperating devices or systems configured to communicate with each other. The communication system may use electric or non-electric sources such as graphic images, electromagnetic radiation, the human voice, digital or analog data, and the like, and may carry information provided by these sources as electric or nonelectric signals.

A communication system may include input transducers or sensors to capture input from the sources. Such sensors may include microphones, cameras, keyboards, motion sensors, light sensors, or other such transducers for capturing some aspect from one location or environment and converting or capturing it as input. A transmitter may be included to convert captured information from the input sources into electric signals and may include aspects such as noise filters, analog-to-digital converters, encoders, modulators, signal amplifiers, and the like to prepare the captured input for transmission. Transmission may be achieved by an antenna, or any suitable device for converting the input to electromagnetic energy in any suitable form.

A receiver may be included to accept signals from a transmitter via a receiving antenna, the receiver may be configured to capture and reconstruct the signal as it was before transmission. The receiver may include components such as noise filters, digital to analog converters, decoders, demodulators, signal amplifiers, and the like. An output transducer may be included that is coupled to the receiver in any suitable way and is configured to convert the signals from a receiver to a different form such as the original form the information was in before it was transmitted. Such output transducers may include speakers for audio output, monitors displaying visual output, motors or actuators for translating the transmitted signal into movement or motion, lights, or other devices responsive to a signal output by the receiver.

“Communications cable” generally refers to a cable configured to carry digital or analog signals.

“Communication Link” generally refers to a connection between two or more communicating entities and may or may not include a communications channel between the communicating entities. The communication between the communicating entities may occur by any suitable means. For example, the connection may be implemented as a physical link, an electrical link, an electromagnetic link, a logical link, or any other suitable linkage facilitating communication.

In the case of a physical link, communication may occur by multiple components in the communication link configured to respond to one another by physical movement of one element in relation to another. In the case of an electrical link, the communication link may be composed of multiple electrical conductors electrically connected to form the communication link.

In the case of an electromagnetic link, the connection may be implemented by sending or receiving electromagnetic energy at any suitable frequency, thus allowing communications to pass as electromagnetic waves. These electromagnetic waves may or may not pass through a physical medium such as an optical fiber, or through free space via one or more sending and receiving antennas, or any combination thereof. Electromagnetic waves may be passed at any suitable frequency including any frequency in the electromagnetic spectrum.

A communication link may include any suitable combination of hardware which may include software components as well. Such hardware may include routers, switches, networking endpoints, repeaters, signal strength enters, hubs, and the like.

In the case of a logical link, the communication link may be a conceptual linkage between the sender and recipient such as a transmission station in the receiving station. Logical link may include any combination of physical, electrical, electromagnetic, or other types of communication links.

“Control Area Network (CAN)” generally refers to a communication system and network protocol that may be used for intercommunication between components or subsystems of a vehicle. A CAN (sometimes referred to colloquially as a “CAN bus”) allows one or more microcontrollers or CAN enabled devices to communicate with each other in real time without a host computer. A CAN may physically connect all nodes together through a two wire bus. The wires may be a twisted pair cable with a 120-ohm characteristic impedance. These wires may be thought of as “high” and “low” connections.

CAN may be thought of as an example of a multi-master serial bus for connecting Electronic Control Units (ECUs) also referred to as “nodes”. Two or more nodes are required on the CAN network to communicate. The complexity of the node can range from a simple I/O device such as a sensor, an active device such as a lamp, transmission, or brake actuator, or an embedded computer or ECU with a CAN interface. A node may also be a gateway allowing a standard computer to communicate over a network connection such as a Universal Serial Bus (USB) or Ethernet port allowing outside devices to be selectively added or removed from the CAN network.

A CAN bus does not require any addressing schemes, as the nodes of the network use unique identifiers that may be provided by programming the individual node before use, or reprogramming between uses. This provides the nodes with information regarding the priority and the urgency of transmitted message.

Each node may include a central processing unit, microprocessor, or host processor. The host processor may be configured to determine what the received messages mean and what messages to transmit in response. A node may be electrically connected to sensors, actuators, lamps, or other electronic devices that can be connected to the host processor. A node may also include a CAN controller, optionally integrated into the microcontroller. The can control may implement the sending and receiving protocols. When receiving, the CAN controller may store the received serial bits from the bus until an entire message is available, which can then be fetched by the host processor (for example, by the CAN controller triggering an interrupt). When sending, the host processor may send the transmit message(s) to the CAN controller, which transmits the bits serially onto the bus when the bus is free. A node may also include a transceiver. When receiving: the transceiver may convert the data stream from CAN bus levels to levels that the CAN controller uses. It may have protective circuitry to protect the CAN controller. When transmitting, the transceiver may convert the data stream from the CAN controller to CAN bus levels.

Each node may be configured to send and receive messages, but not simultaneously. A message or Frame consists primarily of the ID (identifier), which represents the priority of the message, and up to eight data bytes. A CRC, acknowledge slot (ACK) and other overhead are also part of the message. The improved CAN FD extends the length of the data section to up to 64 bytes per frame. The message is transmitted serially onto the bus using a non-return-to-zero (NRZ) format and may be received by all nodes.

CAN data transmission may use a lossless bitwise arbitration method of contention resolution. This arbitration method may require all nodes on the CAN network to be synchronized to sample every bit on the CAN network at the same time. Thus data may be transmitted without a clock signal in an asynchronous format.

The CAN specifications may use the terms “dominant” bits and “recessive” bits where dominant is a logical 0 (actively driven to a voltage by the transmitter) and recessive is a logical 1 (passively returned to a voltage by a resistor). The idle state may be represented by the recessive level (logical 1). If one node transmits a dominant bit and another node transmits a recessive bit then a collision results and the dominant bit “wins”. This means there is no delay to the higher-priority message, and the node transmitting the lower priority message automatically attempts to retransmit, for example, six bit clocks after the end of the dominant message.

All nodes on the CAN network generally operate at the same nominal bit rate, but noise, phase shifts, oscillator tolerance and oscillator drift mean that the actual bit rate may not be the same as the nominal bit rate. Since a separate clock signal is not used, a means of synchronizing the nodes is used. Synchronization is helpful during arbitration since the nodes in arbitration may see both their transmitted data and the other nodes'transmitted data at the same time. Synchronization is also helpful to ensure that variations in oscillator timing between nodes do not cause errors.

Synchronization may start with a hard synchronization on the first recessive to dominant transition after a period of bus idle (the start bit). Resynchronization may occur on every recessive to dominant transition during the frame. The CAN controller may expect the transition to occur at a multiple of the nominal bit time. If the transition does not occur at the exact time the controller expects it, the controller adjusts the nominal bit time accordingly.

Examples of lower-layer (e.g. levels 1 and 2 of the ISO/OSI model), are commercially available from the International Standardization Organization (ISO) and include ISO 11898-1 through 11898-6, as well as ISO 16845-1 and 16845-2.

CAN standards may not include application layer protocols, such as flow control, device addressing, and transportation of data blocks larger than one message, as well as, application data. Other CAN standards are available that are optimized for specific fields of use. These include, but are not limited to:
ARINC 812 or ARINC 825 (for the aviation industry)
CANopen—EN 50325-4 (used for industrial automation)
DeviceNet (used for industrial automation)
EnergyBus—CiA 454 (used for light electrical vehicles)
ISOBUS—ISO 11783 (agriculture)
ISO-TP—ISO 15765-2 (Transport protocol for automotive diagnostic)
SAE J1939 (In-vehicle network for buses and trucks)
MilCAN
NMEA 2000—IEC 61162-3 (marine industry)
Unified Diagnostic Services (UDS)—ISO 14229 (automotive diagnostics)
CANaerospace—Stock (for the aviation industry)
CAN Kingdom—Kvaser (embedded control system)
CCP/XCP (automotive ECU calibration)
GMLAN—General Motors (for General Motors)
RV-C—RVIA (used for recreational vehicles)
SafetyBUS p—Pilz (used for industrial automation)
UAVCAN (aerospace and robotics)

“Controller” generally refers to a mechanical or electronic device configured to control the behavior of another mechanical or electronic device. A controller may include a “control circuit” configured to provide signals or other electrical impulses that may be received and interpreted by the controlled device to indicate how it should behave.

“Control Logic” generally refers to hardware or software configured to implement an automatic decision making process by which inputs are considered, and corresponding outputs are generated. The output may be used for any suitable purpose such as to provide specific commands to machines or processes specifying specific actions to take. Examples of control logic include computer programs executed by a processor to accept commands from a user and generate output according to the logic implemented in the program as executed by the processor. In another example, control logic may be implemented as a series of logic gates, microcontrollers, and the like, electrically connected together in a predetermined arrangement so as to accept input from other circuits or computers and produce an output according to the rules implemented in the logic circuits.

“Current” generally refers to the rate of flow of electric charge past a point or region. An electric current is said to exist when there is a net flow of electric charge through a region. When an electric current flows in a suitably shaped conductor at radio frequencies, radio waves can be generated. These travel at about the speed of light and can cause electric currents in distant conductors. Electric currents cause Joule heating, and may be useful for creating magnetic fields.

“Data” generally refers to one or more values of qualitative or quantitative variables that are usually the result of measurements. Data may be considered “atomic” as being finite individual units of specific information. Data can also be thought of as a value or set of values that includes a frame of reference indicating some meaning associated with the values. For example, the number “2” alone is a symbol that absent some context is meaningless. The number “2” may be considered “data” when it is understood to indicate, for example, the number of items produced in an hour.

Data may be organized and represented in a structured format. Examples include a tabular representation using rows and columns, a tree representation with a set of nodes considered to have a parent-children relationship, or a graph representation as a set of connected nodes to name a few.

The term “data” can refer to unprocessed data or “raw data” such as a collection of numbers, characters, or other symbols representing individual facts or opinions. Data may be collected by sensors in controlled or uncontrolled environments, or generated by observation, recording, or by processing of other data. The word “data” may be used in a plural or singular form. The older plural form “datum” may be used as well.

“Detection Zone” generally refers to an area within which an object may be detected. The detection zone may be either two dimensional and or three dimensional and may be defined the range, sensitivity, or other capabilities or characteristics of one or more sensors. The sensors may be arranged and configured to detect objects within the detection zone by any suitable means. or by a control circuit that is responsive to the sensors.

“Electrically connected” generally refers to a configuration of two objects that allows electricity to flow between them or through them. In one example, two conductive materials are physically adjacent one another and are sufficiently close together so that electricity can pass between them. In another example, two conductive materials are in physical contact allowing electricity to flow between them.

“Electromagnetic Waves” generally refers to waves having a separate electrical and a magnetic component. The electrical and magnetic components of an electromagnetic wave oscillate in phase and are always separated by a 90 degree angle. Electromagnetic waves can radiate from a source to create electromagnetic radiation capable of passing through a medium or through a vacuum. Electromagnetic waves include waves oscillating at any frequency in the electromagnetic spectrum including, but not limited to, radio waves, visible and invisible light, X-rays, and gamma-rays.

“Ground” or “circuit ground” generally refers to a node in an electrical circuit that is designated as a reference node for other nodes in a circuit. It is a reference point in an electrical circuit from which voltages are measured, a common return path for electric current, and/or a direct physical connection to the Earth.

“Ground cable” generally refers to a cable electrically connecting to a circuit ground.

“Lamp” generally refers to an electrical device configured to emit or produce light using electrical power. The generated light may be in the visible range, ultraviolet, infrared, or other light. Example illumination technologies that may be employed in a lamp include, but are not limited to, incandescent, halogen, LED, fluorescent, carbon arc, xenon arc, metal-halide, mercury-vapor, sulfur, neon, sodium-vapor, or others.

“LED Lamp” generally refers to an electrical device that uses Light Emitting Diodes (LEDs) to produce light using electrical power. A lamp may include a single LED, or multiple LEDs.

“Light Emitting Diode” or “LED” generally refers to a diode that is configured to emit light when electrical power passes through it. The term may be used to refer to single diodes as well as arrays of LED's and/or grouped light emitting diodes. This can include the die and/or the LED film or other laminate, LED packages, said packages may include encapsulating material around a die, and the material, typically transparent, may or may not have color tinting and/or may or may not have a colored sub-cover. An LED can be a variety of colors, shapes, sizes and designs, including with or without heat sinking, lenses, or reflectors, built into the package.

“Local Interconnect Network (LIN)” generally refers to a network protocol used for communication between components in vehicles, usually by means of serial communication. LIN may be used also over the vehicle's battery power-line with a special LIN over DC powerline (DC-LIN) transceiver. Features of the protocol include, but are not limited to a single master, up to 16 slaves, Slave Node Position Detection (SNPD) that allows node address assignment after power-up, single wire communications greater than 19.2 Kbits/s with a bus length of 40 meters or less, guaranteed latency times, variable length of data frame (2, 4 and 8 byte frames), multi-cast reception with time synchronization, without crystals or ceramic resonators, data checksum and error detection, detection of defective nodes, and an operating voltage of 12V.

A LIN may be implemented as a single-wire network such as an asynchronous serial network described on ISO 9141. A microcontroller may generate all needed LIN data by software and is connected to the LIN network via a LIN transceiver. The LIN Master may use one or more predefined scheduling tables to start sending and receiving to the LIN bus. These scheduling tables contain relative timing information, where the message sending is initiated. One LIN Frame consists of the two parts header and response. The header is always sent by the LIN Master, while the response is sent by either one dedicated LIN-Slave or the LIN master itself.

Transmitted data within the LIN is transmitted serially as eight bit data bytes with one start bit, one stop-bit, and no parity (break field does not have a start bit and stop bit). Bit rates vary within the range of 1 kbit/s to 20 kbit/s, or more. Data on the bus is divided into recessive (logical HIGH) and dominant (logical LOW). The time normal is considered by the LIN Masters stable clock source, the smallest entity is one bit time (e.g. 52 μs at 19.2 kbit/s).

Data may be transferred across the bus in fixed form messages of selectable lengths. The master task may transmit a header that consists of a break signal followed by synchronization and identifier fields. The slaves may respond with a data frame that consists of between 2, 4 and 8 data bytes plus 3 bytes of control information. Frame types include, unconditional frame, Event-triggered frame, Sporadic frame, Diagnostic frame, User-defined frame, Reserved frame. One example of a standard LIN is maintained by the International Organization for Standardization (ISO) as ISO/AWI 17987

“Memory” generally refers to any storage system or device configured to retain data or information. Each memory may include one or more types of solid-sate electronic memory, magnetic memory, or optical memory, just to name a few. Memory may use any suitable storage technology, or combination of storage technologies, and may be volatile, nonvolatile, or a hybrid combination of volatile and nonvolatile varieties. By way of non-limiting example, each memory may include solid-sate electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM).

Memory can refer to Dynamic Random Access Memory (DRAM) or any variants, including static random access memory (SRAM), Burst SRAM or Synch Burst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (REDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM).

Memory can also refer to non-volatile storage technologies such as non-volatile read access memory (NVRAM), flash memory, non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Domain Wall Memory (DWM) or “Racetrack” memory, Nano-RAM (NRAM), or Millipede memory. Other non-volatile types of memory include optical disc memory (such as a DVD or CD ROM), a magnetically encoded hard disc or hard disc platter, floppy disc, tape, or cartridge media. The concept of a “memory” includes the use of any suitable storage technology or any combination of storage technologies.

“Metallic” generally refers to a material that includes a metal, or is predominately (50% or more by weight) a metal. A metallic substance may be a single pure metal, an alloy of two or more metals, or any other suitable combination of metals. The term may be used to refer to materials that include nonmetallic substances. For example, a metallic cable may include one or more strands of wire that are predominately copper sheathed in a polymer or other nonconductive material.

“Microcontroller” or “MCU” generally refers to a small computer on a single integrated circuit. It may be similar to, but less sophisticated than, a System on a Chip or “SoC”; an SoC may include a microcontroller as one of its components. A microcontroller may contain one or more CPUs (processor cores) along with memory and programmable input/output peripherals. Program memory in the form of ferroelectric RAM, NOR flash or OTP ROM may also be included on the chip, as well as a small amount of RAM. Microcontrollers may be designed for embedded applications, in contrast to the microprocessors used in personal computers or other general purpose applications consisting of various discrete chips.

Microcontrollers may be included in automatically controlled products and devices, such as automobile engine control systems, implantable medical devices, remote controls, office machines, appliances, power tools, toys and other embedded systems. An MCU may be configured to handle mixed signals thus integrating analog components needed to control non-digital electronic systems.

Some microcontrollers may use four-bit words and operate at frequencies as low as 4 kHz, for low power consumption (single-digit milliwatts or microwatts). They will generally have the ability to retain functionality while waiting for an event such as a button press or other interrupt; power consumption while sleeping (CPU clock and most peripherals off) may be just nanowatts, making many of them well suited for long lasting battery applications. Other microcontrollers may serve performance roles, where they may need to act more like a Digital Signal Processor (DSP), with higher clock speeds and power consumption. A micro-controller may include any suitable combination of circuits such as:
1. a central processing unit-ranging from small and simple processors with registers as small as 4 bits or list, to complex processors with registers that are 32, 64, or more bits
2. volatile memory (RAM) for data storage
3. ROM, EPROM, EEPROM or Flash memory for program and operating parameter storage
4. discrete input and output bits, allowing control or detection of the logic sate of an individual package pin
5. serial input/output such as serial ports (UARTs)
6. other serial communications interfaces like I²C, Serial Peripheral Interface and Controller Area Network for system interconnect
7. peripherals such as timers, event counters, PWM generators, and watchdog
8. clock generator-often an oscillator for a quartz timing crystal, resonator or RC circuit
9. many include analog-to-digital converters, some include digital-to-analog converters
10. in-circuit programming and in-circuit debugging support

“Movement Sensor” or “Motion Sensor” generally refers to a device operable to detect motion or movement. Examples include the sensors that include an optical, microwave, and/or acoustic receiver and optionally, a transmitter as well. The transmitter and receiver may be mounted together, or mounted remotely from one another. In other examples, movement or motion may be determined by an accelerometer, by tracking signals from navigational equipment such as GPS, cellular, and the like, or by any other suitable means.

“Multiple” as used herein is synonymous with the term “plurality” and refers to more than one, or by extension, two or more.

“Network” or “Computer Network” generally refers to a telecommunications network that allows computers to exchange data. Computers can pass data to each other along data connections by transforming data into a collection of datagrams or packets. The connections between computers and the network may be established using either cables, optical fibers, or via electromagnetic transmissions such as for wireless network devices.

Computers coupled to a network may be referred to as “nodes” or as “hosts” and may originate, broadcast, route, or accept data from the network. Nodes can include any computing device such as personal computers, phones, servers as well as specialized computers that operate to maintain the flow of data across the network, referred to as “network devices”. Two nodes can be considered “networked together” when one device is able to exchange information with another device, whether or not they have a direct connection to each other.

Examples of wired network connections may include Digital Subscriber Lines (DSL), coaxial cable lines, or optical fiber lines. The wireless connections may include BLUETOOTH, Worldwide Interoperability for Microwave Access (WiMAX), infrared channel or satellite band, or any wireless local area network (Wi-Fi) such as those implemented using the Institute of Electrical and Electronics Engineers'(IEEE) 802.11 standards (e.g. 802.11(a), 802.11(b), 802.11(g), or 802.11(n) to name a few). Wireless links may also include or use any cellular network standards used to communicate among mobile devices including 1G, 2G, 3G, or 4G. The network standards may qualify as 1G, 2G, etc. by fulfilling a specification or standards such as the specifications maintained by International Telecommunication Union (ITU). For example, a network may be referred to as a “3G network” if it meets the criteria in the International Mobile Telecommunications-2000 (IMT-2000) specification regardless of what it may otherwise be referred to. A network may be referred to as a “4G network” if it meets the requirements of the International Mobile Telecommunications Advanced (IMTAdvanced) specification. Examples of cellular network or other wireless standards include AMPS, GSM, GPRS, UMTS, LTE, LTE Advanced, Mobile WiMAX, and WiMAX-Advanced.

Cellular network standards may use various channel access methods such as FDMA, TDMA, CDMA, or SDMA. Different types of data may be transmitted via different links and standards, or the same types of data may be transmitted via different links and standards.

The geographical scope of the network may vary widely. Examples include a body area network (BAN), a personal area network (PAN), a low power wireless Personal Area Network using IPv6 (6LoWPAN), a local-area network (LAN), a metropolitan area network (MAN), a wide area network (WAN), or the Internet.

A network may have any suitable network topology defining the number and use of the network connections. The network topology may be of any suitable form and may include point-to-point, bus, star, ring, mesh, or tree. A network may be an overlay network which is virtual and is configured as one or more layers that use or “lay on top of” other networks.

A network may utilize different communication protocols or messaging techniques including layers or stacks of protocols. Examples include the Ethernet protocol, the internet protocol suite (TCP/IP), the ATM (Asynchronous Transfer Mode) technique, the SONET (Synchronous Optical Networking) protocol, or the SDE1 (Synchronous Digital Elierarchy) protocol. The TCP/IP internet protocol suite may include application layer, transport layer, internet layer (including, e.g., IPv6), or the link layer.

“Optionally” as used herein means discretionary; not required; possible, but not compulsory; left to personal choice.

“Predominately” as used herein is synonymous with greater than 50%.

“Processor” generally refers to one or more electronic components configured to operate as a single unit configured or programmed to process input to generate an output. Alternatively, when of a multi-component form, a processor may have one or more components located remotely relative to the others. One or more components of each processor may be of the electronic variety defining digital circuitry, analog circuitry, or both. In one example, each processor is of a conventional, integrated circuit microprocessor arrangement, such as one or more PENTIUM, i3, i5 or i7 processors supplied by INTEL Corporation of Santa Clara, California, USA. Other examples of commercially available processors include but are not limited to the X8 and Freescale Coldfire processors made by Motorola Corporation of Schaumburg, Illinois, USA; the ARM processor and TEGRA System on a Chip (SoC) processors manufactured by Nvidia of Santa Clara, California, USA; the POWER7 processor manufactured by International Business Machines of White Plains, New York, USA; any of the FX, Phenom, Athlon, Sempron, or Opteron processors manufactured by Advanced Micro Devices of Sunnyvale, California, USA; or the Snapdragon SoC processors manufactured by Qualcomm of San Diego, California, USA.

A processor also includes Application-Specific Integrated Circuit (ASIC). An ASIC is an Integrated Circuit (IC) customized to perform a specific series of logical operations is controlling a computer to perform specific tasks or functions. An ASIC is an example of a processor for a special purpose computer, rather than a processor configured for general-purpose use. An application-specific integrated circuit generally is not reprogrammable to perform other functions and may be programmed once when it is manufactured.

In another example, a processor may be of the “field programmable” type. Such processors may be programmed multiple times “in the field” to perform various specialized or general functions after they are manufactured. A field-programmable processor may include a Field-Programmable Gate Array (FPGA) in an integrated circuit in the processor. FPGA may be programmed to perform a specific series of instructions which may be retained in nonvolatile memory cells in the FPGA. The FPGA may be configured by a customer or a designer using a hardware description language (HDL). In FPGA may be reprogrammed using another computer to reconfigure the FPGA to implement a new set of commands or operating instructions. Such an operation may be executed in any suitable means such as by a firmware upgrade to the processor circuitry.

Just as the concept of a computer is not limited to a single physical device in a single location, so also the concept of a “processor” is not limited to a single physical logic circuit or package of circuits but includes one or more such circuits or circuit packages possibly contained within or across multiple computers in numerous physical locations. In a virtual computing environment, an unknown number of physical processors may be actively processing data, the unknown number may automatically change over time as well.

The concept of a “processor” includes a device configured or programmed to make threshold comparisons, rules comparisons, calculations, or perform logical operations applying a rule to data yielding a logical result (e.g. “true” or “false”). Processing activities may occur in multiple single processors on separate servers, on multiple processors in a single server with separate processors, or on multiple processors physically remote from one another in separate computing devices.

“Portion” means a part of a whole, either separated from or integrated with it.

“Power Cable” generally refers to a cable configured to transfer electrical power as part of an electrical circuit. A power cable may be used exclusively to transfer power, or it may be used to also transfer signals, such as in the case of a Power Line Communication (PLC) system.

“Power Line Communication (PLC)” generally refers to a system of electronic communication that transmits and receives signals on the same circuit used to transfer power. Examples including system that send data over common AC wiring in a home, or Broadband over Power Line (BPL) systems for carrying network traffic over high voltage transmission lines, as well as systems for in-vehicle communications.

In the vehicle context, data, voice, music and video signals may be transferred to throughout a vehicle by over direct current DC battery power-line. One example of is DC-BU, a technology for reliable and economical communication over noisy DC or AC power lines. Digital input data may be modulated and carried over the power line and then demodulated into the original digital data up receipt.

In DC-BUS or other PLC implementations, the signaling technology is byte oriented, allowing transfer of a single UART data byte or more over noisy channel (such as the powerline) at bit-rate up to 115.2 kbit/s, each transmitted byte is protected against errors caused by noisy environment. This method may operate on a channel ranging in the HF band. A narrow band signaling modulation may be used that is based on a combination of phase changes to transfer each byte. There is no restriction to the number of bytes. Any Universal Asynchronous Receiver-Transmitter (UART) based standards such as RS-232, RS-485 and LIN-bus can use a DC-BUS as a physical layer (as referred to in the OSI model).

“Sensor” generally refers to a transducer configured to sense or detect a characteristic of the environment local to the sensor. For example, sensors may be constructed to detect events or changes in quantities or sensed parameters providing a corresponding output, generally as an electrical or electromagnetic signal. A sensor's sensitivity indicates how much the sensor's output changes when the input quantity being measured changes.

“Sense parameter” generally refers to a property of the environment detectable by a sensor. As used herein, sense parameter can be synonymous with an operating condition, environmental factor, sensor parameter, or environmental condition. Sense parameters may include temperature, air pressure, speed, acceleration, the presence or intensity of sound or light or other electromagnetic phenomenon, the strength and/or orientation of a magnetic or electrical field, and the like.

“Signal” generally refers to a function or means of representing information. It may be thought of as the output of a transformation or encoding process. The concept generally includes a change in the state of a medium or carrier that conveys the information. The medium can be any suitable medium such as air, water, electricity, magnetism, or electromagnetic energy such as in the case of radio waves, pulses of visible or invisible light, and the like.

As used herein, a “signal” implies a representation of meaningful information. Arbitrary or random changes in the state of a carrier medium are generally not considered “signals” and may be considered “noise”. For example, arbitrary binary data streams are not considered as signals. On the other hand, analog and digital signals that are representations of analog physical quantities are examples of signals. A signal is commonly not useful without some way to transmit or send the information, and a receiver responsive to the transmitter for receiving the information.

In a communication system, for example, a transmitter encodes a message to a signal, which is carried to a receiver by the communications channel. For example, the words “The time is 12 o'clock” might be the message spoken into a telephone. The telephone transmitter may then convert the sounds into an electrical voltage signal. The signal is transmitted to the receiving telephone by wires, at the receiver it is reconverted into sounds.

Signals may be thought of as “discrete” or “continuous.” Discrete-time signals are often referred to as time series in other fields. Continuous-time signals are often referred to as continuous signals even when the signal functions are not continuous, such as in a square-wave signal.

Another categorization is signals which are “discrete-valued” and “continuous-valued”. Particularly in digital signal processing a digital signal is sometimes defined as a sequence of discrete values, that may or may not be derived from an underlying continuous-valued physical process. In other contexts, digital signals are defined as the continuous-time waveform signals in a digital system, representing a bit-stream. In the first case, a signal that is generated by means of a digital modulation method may be considered as converted to an analog signal, while it may be considered as a digital signal in the second case.

“Socket” generally refers a device into which something fits in order to electrically and/or physically connect another electrical device to a circuit.

“Stop-tail-turn Lamp” or “STT Lamp” generally refers to a lamp which is compliant with present legal and/or regulatory requirements for a truck or a trailer such as illuminated surface area, candela, and otherwise. Such regulations include, for example, Title 49 of the U.S. Code of Federal Regulations, section 571.108, also known as Federal Motor Vehicle Safety Standard (FMVSS) 108.

“Terminal” generally refers to a plug, socket or other connection (male, female, mixed, hermaphroditic, or otherwise) for mechanically and electrically connecting two or more wires or other conductors.

“Trailer” generally refers to a vehicle that is configured to be moved about using some other vehicle coupled to the trailer.

“Truck” generally refers to a powered truck (also known as a tractor or cab) for pulling a trailer.

“Vehicle” generally refers to a self-propelled or towed device for transportation, including without limitation, car, truck, bus, boat, tank or other military vehicle, airplane, truck trailer, truck cab, boat trailer, other trailer, emergency vehicle, and motorcycle.

What is claimed is:

1. A collision warning device for a commercial vehicle, comprising:
a sensor defining a detection zone around the commercial vehicle, wherein the sensor is operable to detect an approaching vehicle in proximity to the commercial vehicle;
a control circuit responsive to the sensor, wherein the control circuit is configured to determine a collision parameter selected from the group consisting essentially of: (a) time to collision; (b) distance between the sensor and the approaching vehicle; (c) closure rate between the sensor and the approaching vehicle; and (d) combinations thereof; and
a warning device responsive to the control circuit, wherein the warning device is operable to emit a warning signal toward the approaching vehicle;
wherein the sensor communicates with a vehicle control box via a data bus in the commercial vehicle; and
wherein the warning device receives power from a metallic power cable of the trailer.

2. The device of claim 1, wherein the sensor is mounted on a side of the commercial vehicle to define a lateral detection zone extending outwardly from the side, and wherein the control circuit is configured to detect the approaching vehicle within the lateral detection zone to mitigate risk of side-impact collisions.

3. The device of claim 2, wherein the control circuit is programmed with triggering criteria specific to side-impact collisions, the triggering criteria differing from criteria for rear-impact collisions and including time-to-collision thresholds adapted for lateral approaches.

4. The device of claim 1, wherein the sensor is one of a plurality of sensors positioned at multiple locations on the commercial vehicle, including at least one sensor on a rear of the commercial vehicle and at least one sensor on a side of the commercial vehicle, to provide multi-directional detection zones around the commercial vehicle.

5. The device of claim 1, wherein the data bus is a CAN bus, and wherein the sensor communicates operational data to the control unit via the CAN bus.

6. The device of claim 1, wherein the warning device includes at least one of an amber lamp, a red lamp, or any combination thereof.

7. The device of claim 1, wherein the control circuit activates the warning device based on predetermined thresholds related to the collision parameter, and wherein the predetermined thresholds specifying a first warning when the time to collision is less than six seconds, a second different warning when the time to collision is less than four seconds, and a third different warning when the time to collision is less than two seconds.

8. The device of claim 1, comprising:
an operator indicator mounted in a cab of the commercial vehicle or a vehicle coupled to the commercial vehicle, and wherein the operator indicator is responsive to the control circuit to display a warning for the driver of the commercial vehicle when the collision warning is triggered.

9. The device of claim 1, wherein the commercial vehicle is selected from the group consisting of a truck trailer, a truck, a bus, a dump truck, a firetruck, and a delivery van.

10. The device of claim 1, wherein the sensor emits electromagnetic energy to detect the approaching vehicle, the electromagnetic energy having a frequency ranging between 100 MHz and 100 PHz.

11. A collision warning device for a commercial vehicle, comprising:
a sensor defining a detection zone around the commercial vehicle and configured to detect an approaching vehicle in proximity to the commercial vehicle;
a control circuit responsive to the sensor, wherein the control circuit is configured to determine a time to collision for the approaching vehicle, to compare the time to collision to triggering criteria, and to trigger a collision warning when the triggering criteria are satisfied;
a warning indicator responsive to the control circuit, wherein the warning indicator has one or more lamps that are arranged and configured to emit a warning signal towards the approaching vehicle, wherein the triggering criteria include predetermined thresholds specifying activation of one or more amber lamps when the time to collision is less than six seconds, activation of one or more red lamps when the time to collision is less than four seconds, and activation of the one or more red and amber lamps when the time to collision is less than two seconds; and
a housing containing the sensor, the warning indicator, the one or more lamps, and the control circuit, wherein the housing is mountable to the commercial vehicle.

12. The device of claim 11, wherein the sensor is mounted on a side of the commercial vehicle to define a lateral detection zone extending outwardly from the side, and wherein the control circuit is configured to detect the approaching vehicle within the lateral detection zone to mitigate risk of side-impact collisions.

13. The device of claim 12, wherein the control circuit is programmed with triggering criteria specific to side-impact collisions, the triggering criteria differing from criteria for rear-impact collisions and including time-to-collision thresholds adapted for lateral approaches.

14. The device of claim 11, wherein the sensor is one of a plurality of sensors positioned at multiple locations on the commercial vehicle, including at least one sensor on a rear of the commercial vehicle and at least one sensor on a side of the commercial vehicle, to provide multi-directional detection zones around the commercial vehicle.

15. The device of claim 11, wherein a cab warning device is responsive to the control circuit, wherein the cab warning device is located in a cabin of the commercial vehicle or a vehicle coupled to the commercial vehicle, and wherein the control circuit is configured to activate the cab warning device when a collision warning is triggered.

16. The device of claim 11, wherein the sensor emits electromagnetic energy to detect the approaching vehicle, the electromagnetic energy having a frequency ranging between 100 MHz and 100 PHz.

17. The device of claim 11, comprising a camera defining a field of view that includes an area around the commercial vehicle, wherein the camera is responsive to the control circuit, wherein the camera is operable to capture imagery when the control circuit triggers a collision warning, and wherein the camera is mounted inside the housing.

18. The device of claim 11, wherein the one or more red and amber lamps are mounted in the housing.

19. The device of claim 11, comprising one or more red, white, or amber strobe lamps operable to flash in response to a collision warning generated by the control circuit, wherein the one or more strobe lamps are mounted in the housing.

20. The device of claim 11, wherein the commercial vehicle is selected from the group consisting of a truck trailer, a truck, a bus, a dump truck, a firetruck, and a delivery van.
